(19) United States
(12) Patent Application Publication
(10) Pub. No.: US 2026/0030706 A1
(43) Pub. Date: Jan. 29, 2026

(54) DYNAMIC RECOMMENDATION GENERATION USING STATISTICAL AND ARTIFICIAL INTELLIGENCE MODELLING

(71) Applicant: Crypto Tutors, LLC, Orlando, FL (US)

(72) Inventors: Nina Blankenship, Orlando, FL (US); Lisa Francoeur, Orlando, FL (US); Moeti Ncube, Orlando, FL (US)

(21) Appl. No.: 19/280,768

(22) Filed: Jul. 25, 2025

Related U.S. Application Data
(60) Provisional application No. 63/675,540, filed on Jul. 25, 2024.

(51) Int. Cl. G06Q 50/20; G06Q 10/1053

(52) U.S. Cl. CPC G06Q 50/2057; G06Q 10/1053

(57) ABSTRACT

A method and system for generating recommendations and personalized learning paths is disclosed. The system helps identify users' skill gaps through an Agentic AI tutor, which provides tailored instructions on the projects to build a complete portfolio and achieve job qualification. This qualification process, informed by industry standards, job descriptions, and hiring manager input, accelerates the employment by automatically recommending qualified candidate to hiring managers. In some embodiments, the method includes receiving a first set of data from a first user, generating recommendations for the first user by processing the first set of data using a non-parametric algorithm, using AI models to generate a personalized learning path for the first user based on the recommendations, providing guidance to the first user through verified activities aligned with the personalized learning path, and dynamically displaying the personalized learning path to the first user and one or more second users.

### CROSS REFERENCE TO RELATED APPLICATION

This application claims the benefit of U.S. Provisional Patent Application No. 63/675,540, titled “System and Method for Dynamic Recommendation Generation using Advanced Statistical Methods,” and filed on Jul. 25, 2024, the entire content of which is incorporated by reference herein.

### TECHNICAL FIELD

This disclosure relates to a non-parametric approach for providing dynamic, real-time recommendations and progression paths using advanced statistical and artificial intelligence (AI) methods.

### BACKGROUND

Numerous data collection and analytics tools can help automate foundational tasks for people by generating recommendations in various fields. For example, a computer-based academic and career planning tool may receive user information, and/or academic achievements, and provide match recommendations to the user. However, these tools face many challenges. For example, ambiguous skill definitions may cause misalignment of career choices. Relying on existing skill settings can exclude individuals who have potential to learn and grow from job recommendations. Lacking the ability to obtain accurate, quality data from users may misguide decision-making of employment matching.

An efficient, reliable system and method for generating comprehensive recommendations is desired.

### SUMMARY

To address the aforementioned shortcomings, a method and a system for generating recommendations and learning paths are disclosed herein. In some embodiments, the method receives a first set of data from a first user, the first set of data including data of hobbies and interests and generates one or more recommendations for the first user by processing the first set of data using a non-parametric algorithm. The method also uses one or more artificial intelligence (AI) models to generate a personalized learning path for the first user based on at least one of the one or more recommendations. The method further provides guidance to the first user through verified activities aligned with the personalized learning path, and dynamically displays the personalized learning path to the first user and one or more second users.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIGS. 1A-1G illustrate exemplary graphical user interfaces (GUIs) for presenting data (e.g., survey, recommendations) to users and receiving user responses, according to some embodiments.

FIG. 2 illustrates an exemplary table showing the back-end processing of the disclosed system when accepting user inputs, according to some embodiments.

FIG. 3 illustrates exemplary user hobby data for a job function, according to some embodiments.

FIG. 4 illustrates an exemplary table including simulation data, according to some embodiments.

FIG. 5 illustrates an exemplary table for probability calculation, according to some embodiments.

FIGS. 6A-6C illustrate exemplary GUIs for helping users discover career paths and become qualified, according to some embodiments.

FIGS. 7A-7C illustrate exemplary GUIs providing a student learning path, according to some embodiments.

FIGS. 8A-8C illustrate exemplary dashboards for students and managers, according to some embodiments.

FIGS. 9A-9C illustrate an exemplary dashboard specialized for hiring managers and an underlying algorithm, according to some embodiments.

FIG. 10 illustrates a flowchart of generating recommendations and personalized learning paths, according to some embodiments.

FIG. 11 illustrates a block diagram of an example computer system that may be used in implementing the technology described herein, according to some embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview

Recommendation systems play an important role in helping users navigate complex decisions across various domains, such as employment, education, digital content, smart devices, and internet of things (IOT), etc. Traditional systems often rely on structured, historical data (e.g., user profiles, past selections, etc.) or standardized test results. These systems typically require predefined models or fixed attributes, limiting their ability to recognize nuanced patterns. The present disclosure proposes a powerful tool for generating accurate and personalized recommendations across a wide range of applications by leveraging non-parametric approaches. These approaches offer key advantages such as dynamic data collection, flexible hobby selection, robust advanced statistical and AI modeling, etc.

In some embodiments, the disclosed system may perform one or more AI approaches and/or statistical approaches to process received information based on data segregation. The received information may be a sample of hobbies selected and ranked by users from a population of data (e.g., predefined data). Hobbies may help define a unique individual, which include activities that a person continues to do and are important to achieve a goal (e.g., enjoying a career). The disclosed system may process the information received from users using survey data segregated by category (e.g., job functions and job titles). The survey data often refers to structured user responses through questionnaires or forms. For example, in the context of a career recommendation system, the survey data may include preferences or goals (e.g., desired career paths), choices (e.g., preferred work style), demographic or background information, and/or self-reported interests or hobbies.

Typical collaborative filtering algorithms rely on user-item interactions and similarity measures to provide recommendations. These algorithms often struggle with the cold-start problem (i.e., lack of data for new users or items) and can be limited by the sparsity of the interaction matrix. By using survey data and dynamic hobby collection, the disclosed system, however, mitigates these issues and provides more comprehensive and personalized recommendations (even in data-sparse scenarios).

Furthermore, due to the non-parametric nature and incorporation of diverse hobbies, the disclosed system is able to provide a broad and varied range of recommendations. The algorithm described herein may use an arbitrary number of hobbies, and thus may be applied in generating recommendations for various areas including job hunting, dating, moving content, travel, music, etc. In contrast, other algorithms (e.g., content-based filtering algorithms), which make recommendations based on the attributes of items and users, are generally only applicable to a specific set of attributes. Therefore, each of these algorithms relates to generating recommendations for a particular user case (e.g., dating, movie content). In some scenarios, the other algorithms may also recommend similar items repeatedly and generate narrow-scoped recommendations.

The disclosed system is also advantageous over a combination of recommendation systems. Such systems, e.g., combining collaborative and content-based filtering methods, often rely on complex analytical models and require complex tuning and balancing. The disclosed system, on the other hand, does not rely on skills and is convenient and robust through bootstrap and Monte Carlo methods. The disclosed system offers a straightforward yet powerful alternative, with the additional benefit of real-time adaptability. For example, upon the user selection of nine hobbies (as described below), recommendations (e.g., 10 web3 job recommendations identified from >300 web3 job titles) may be provided in minutes (e.g., <5 minutes), thereby improving user experience.

The present disclosure proposes a novel non-parametric approach for providing dynamic, real-time recommendations based on fluid data collection and hobby and interest selection. Hobbies may be collected and ranked from a set of identified users (e.g., professionals in a specific area, students in a specific major). These hobbies include routine activities, natural or learned abilities, and other traits that may help a user to achieve a goal, for example, assisting a student to find matched majors in colleges or helping a customer select satisfactory products, etc. In the context of job searching, hobbies indicate features that can help a professional excel in his/her role and align with a company's culture. The most prominent hobbies can be used to evaluate a person's interest in a position. Even if the person is uncertain about how their hobbies relate to a job function, the disclosed system can seek to identify structural connections that are beyond the surface level depth by performing hobby alignment, thereby increasing the probability of meeting the uncertain expectation and preventing the person from missing the opportunity to become successful in that position.

In the context of a job matching scenario, the resulting recommendations include one or more job functions into which a user is likely classified, one or more corresponding job matches (e.g., job titles) associated with those job functions, etc. In some examples, at least three job functions and about 10 job titles are provided. A job function is a detailed list of an employee's actions and duties as part of his/her role.

Notably, the disclosed system employs advanced statistical modeling (e.g., Monte Carlo methods) in combination with AI to generate personalized job recommendations and progression paths. The disclosed system integrates career assessments, dynamic curricula, real-world job trajectory data, and employer demand into a unified, intelligent career-matching mechanism.

The disclosed system supports an intelligent, agent-driven recommendation and qualification mechanism that bridges users' hobbies/interests, skill gaps, prior experience, and related factors with real-world career paths, using a proactive and adaptive AI engine/model. Once a user (e.g., student, professional) selects a target job title (e.g., software engineer), an agentic AI engine may be activated to drive a personalized, multimodal learning journey. The AI agent may conduct skill gap assessments, synthesize available credentials (or lack thereof), and dynamically build a tailored learning plan (e.g., a personalized curriculum) using structured and unstructured data inputs. This process enables highly individualized learning that adapts to each user's educational level, preferences, and professional goals.

In contrast to conventional systems (e.g., LinkedIn) that use passive, profile-based filtering and keyword matching, the disclosed system employs proactive engagement and qualification-based filtering. For example, instead of awaiting user interactions, the disclosed AI agent may actively prompt users to complete courses, pursue specific certifications, or consider job openings aligned with their path. The AI agent not only learns from internal assessment data but also incorporates live, real-world data (e.g., live job market data, career path modelings, etc.). In some embodiments, the disclosed system may construct a professional roadmap (e.g., a job seniority map) to inform users of the steps needed to reach specific, advanced positions (e.g., chief information security officer).

In some embodiments, the disclosed system uses proof of qualification. Users are required to complete verified, project-based work to gain a specific status (e.g., “VIP status”). Once earned, this status enables automated visibility to hiring managers without requiring traditional job applications. As a result, the disclosed system filters and presents only qualified candidates, eliminating the inefficiencies of traditional hiring funnels. For example, only users with completed, validated portfolios are surfaced to employers, and only for roles they are demonstrably prepared for.

It is important to note that a user or candidate does not manually apply for a job. Instead, once the candidate achieves the required qualification through proof-of-projects, the disclosed system automatically recommends the candidate's profile to a hiring manager and actively applies to the job on behalf of the candidate. This capability represents a key differentiator from conventional platforms (e.g., LinkedIn). Unlike LinkedIn, the disclosed system identifies the specific projects a candidate needs to complete to qualify for a given role/job and handles the application process automatically once those qualifications are met.

In some embodiments, the disclosed system further enhances candidate credibility through the integration of blockchain-based credentialing. Completed projects and certifications may be embedded on-chain, providing tamper-proof validation of user qualifications. This feature offers a level of authenticity and security that distinguishes the disclosed system from existing learning management systems or job-matching platforms.

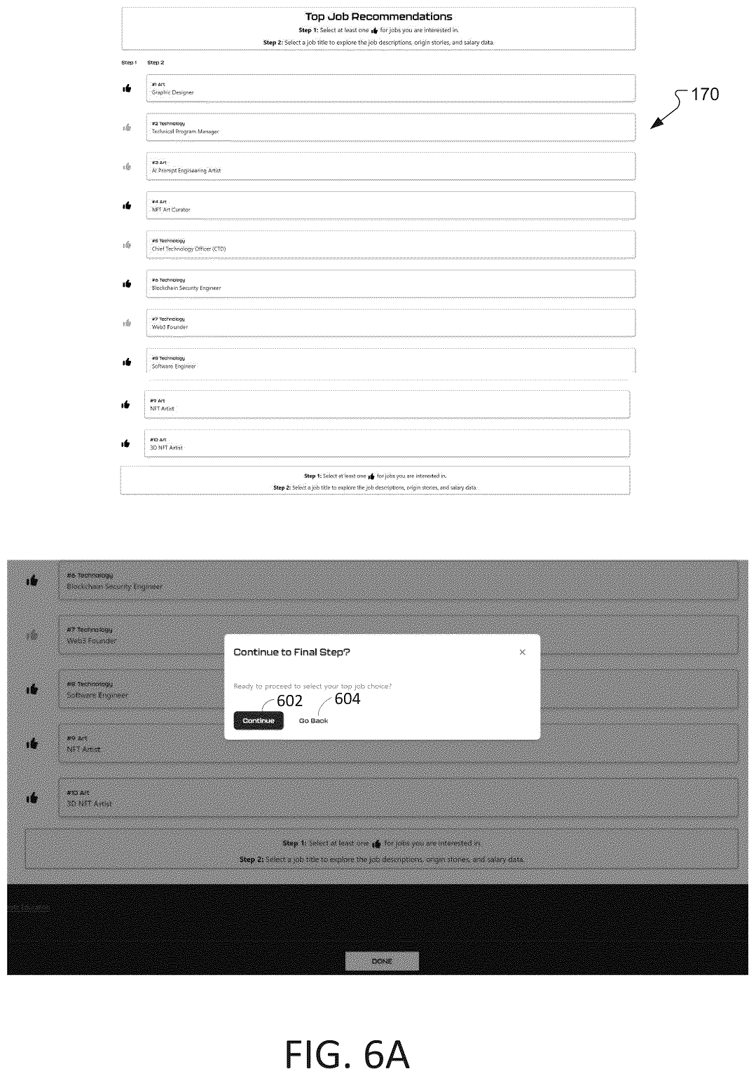

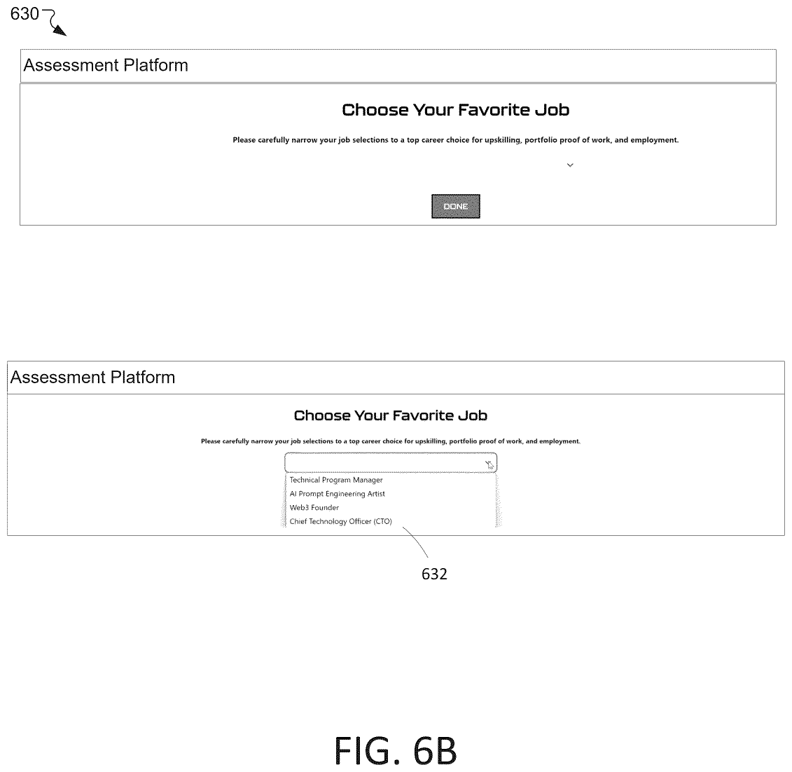

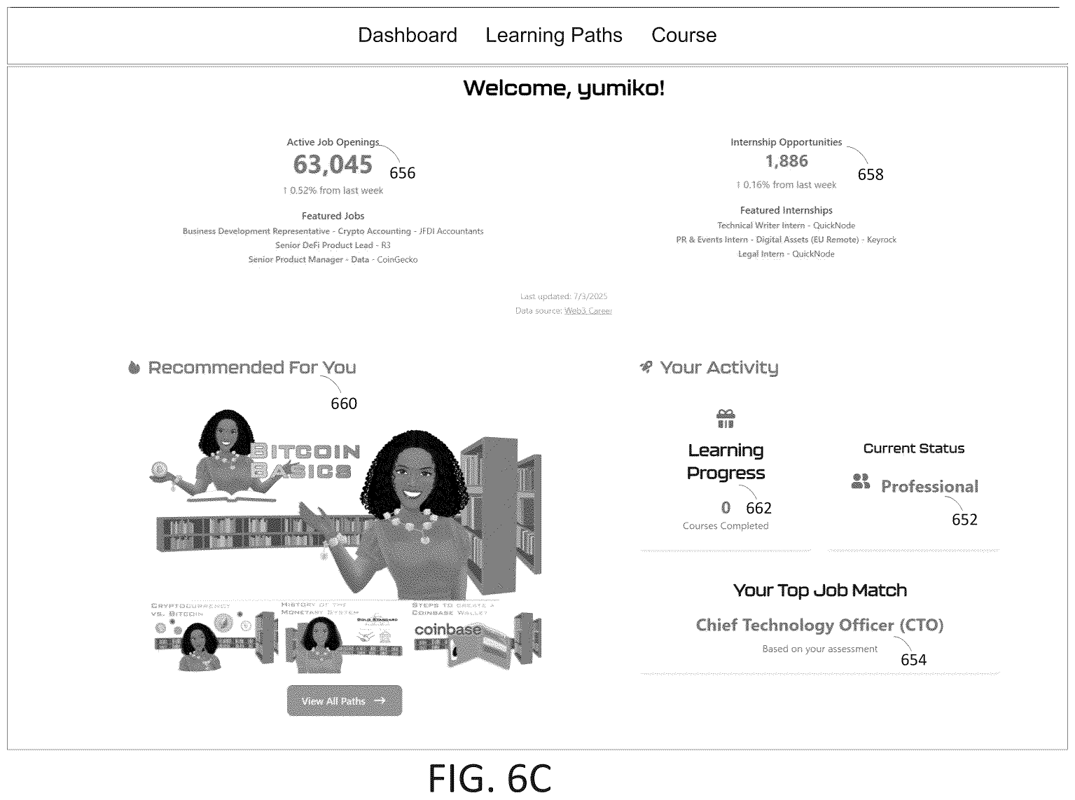

The disclosed system supports a wide range of domains, including both web3 and non-web3 domains (e.g., AI, IoT, zero trust, cloud computing, machine learning, etc.). This domain flexibility is enabled by a scalable algorithmic framework that powers multiple role-specific dashboards. Each dashboard is tailored to align with a user's objective, whether hiring, learning, or management, allowing the disclosed system to distinguish between users engaged in recruitment functions (e.g., talent acquisition) and those in employee development or upskilling. This structure enables differentiated user experiences within a unified corporate portal. The AI-driven recommendation and progression tracking dashboards, supported by the underlying scalable framework, are further detailed with reference to FIGS. 6-9.

While the present disclosure hereafter is mainly described in the context of job-matching recommendations for simplicity and clarity, it should be noted that the system and approach described herein are also applicable to other types of recommendations in other fields such as education, healthcare, finance, smart device deployment, and configuration, etc.

### System Implementation

### Data Cleaning

In some embodiments, the disclosed system may perform cleaning on the received data prior to generating comprehensive recommendations based on the received data. The disclosed system may apply data cleaning to fix or remove incorrect, corrupted, incomplete, duplicate, or other inappropriate data.

In a job matching scenario, in some embodiments, the disclosed system may first send one or more surveys to a set of candidates. For example, the disclosed system may send thousands of LinkedIn® inmail messages to web3 professionals who work in the United States. Each message may include a link to the survey, and the survey may include carefully designed questions and/or hobbies relating to the analysis goal (e.g., finding a match for a web3 professional position). The LinkedIn® inmail allows the disclosed system to send messages to users who have not yet been connected. Using the link included in the message, the survey participants may fill out the survey form on their associated user devices (e.g., mobile phones, tablets) through one or more graphical user interfaces (GUIs) generated by the disclosed system. In some embodiments, the disclosed system may also interact with the survey participants to help them fill out the survey, for example, through online conversations or through a meeting scheduled with an expert using phone or online communication platforms. In other embodiments, the disclosed system may collect data (e.g., hobbies and interests) through a specific-designed platform.

The disclosed system performs data cleaning based on the received survey responses. For example, the disclosed system may remove any participants who did not fully fill out the required sections of the survey, and who did not provide enough information to verify they were a legitimate person. The disclosed system may also remove anyone who is not a professional in a specific area and thus may not aim to pursue specific employment or provide valid responses. In the example scenario, the disclosed system may remove anyone who is not a web3 professional.

Additionally, prior to sending the survey out, the disclosed system may conduct a field test of the survey with some testers (e.g., a specific number of web3 professionals) to get feedback on the survey structure, wording, format, etc. For example, the disclosed system may adjust the structure of how certain questions were asked, add certain hobbies based on feedback from the field testers, etc.

### Job Function Problem

The disclosed system may further perform fine-tune operations based on the survey responses. As a result, unclear definitions, the number of hobbies, the sample size, etc. can be adjusted. In the example job matching scenario, an important fine-tuning task relates to providing a clear, concise definition for a job function. A job function is a detailed list of an employee's actions and duties as part of his/her role. For example, the disclosed system allows some users to identify a job function based only on titles (e.g., Legal, Technology, etc.), but this may cause confusion regarding which function a user should be classified into. That is, a user may be a software engineer but he would then select the “research” or “development” job function instead of the “technology” job function. This requires the disclosed system to conduct more, deep cleaning operations to classify each participant into a correct job function.

Therefore, one technical problem solved by the disclosed system is to improve the accuracy of initial recommendations (e.g., on the level of job functions) and accordingly improve the accuracy of subsequent recommendations (e.g., job descriptions associated with a job function). As a result, the overall accuracy and efficiency of the recommendation system is significantly increased.

### Recommendation Generation

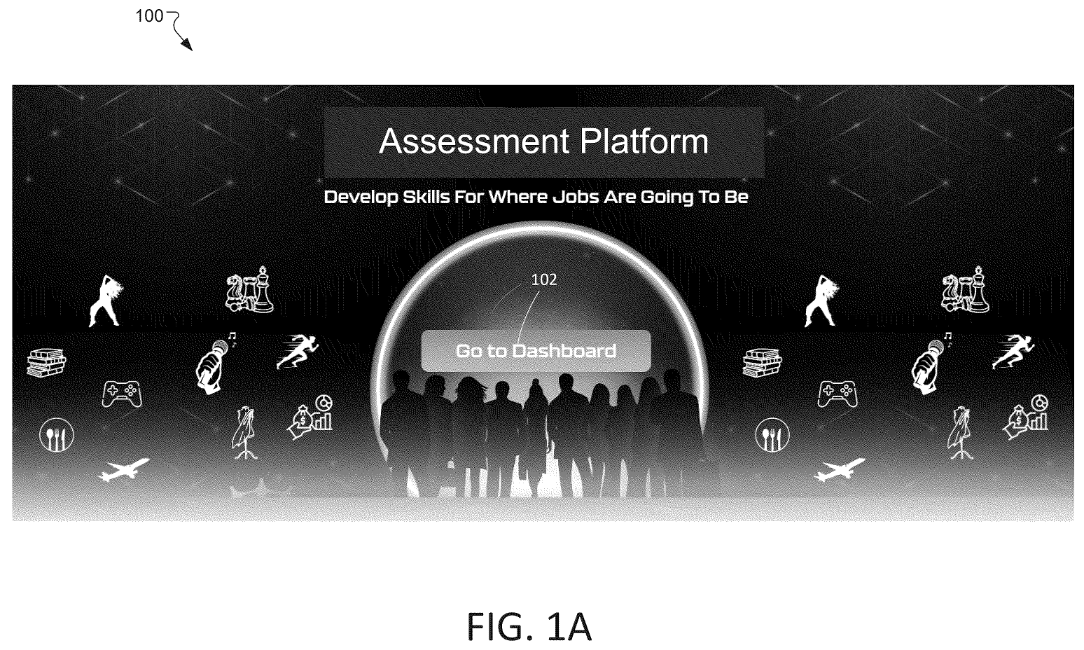

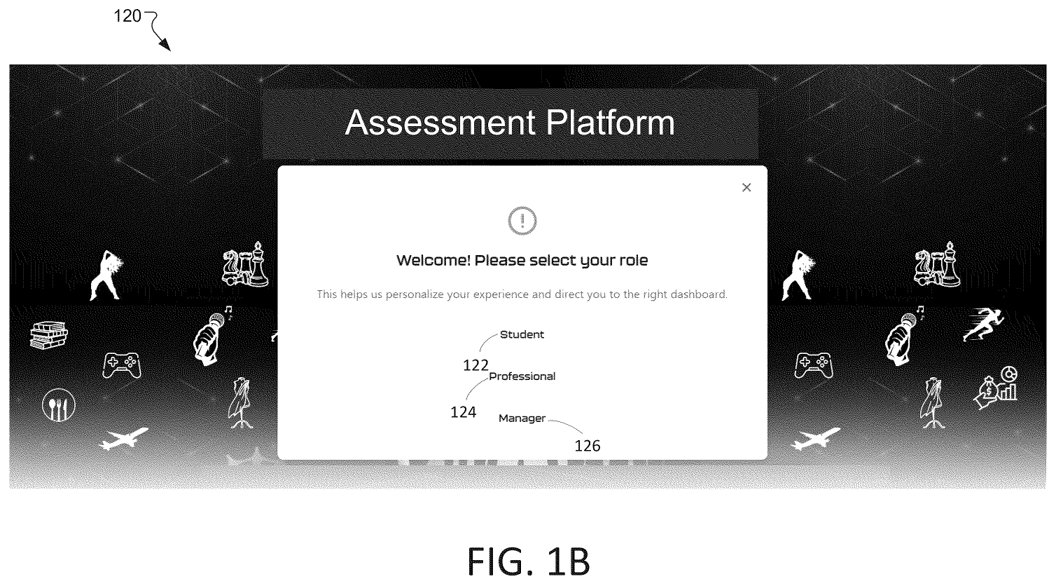

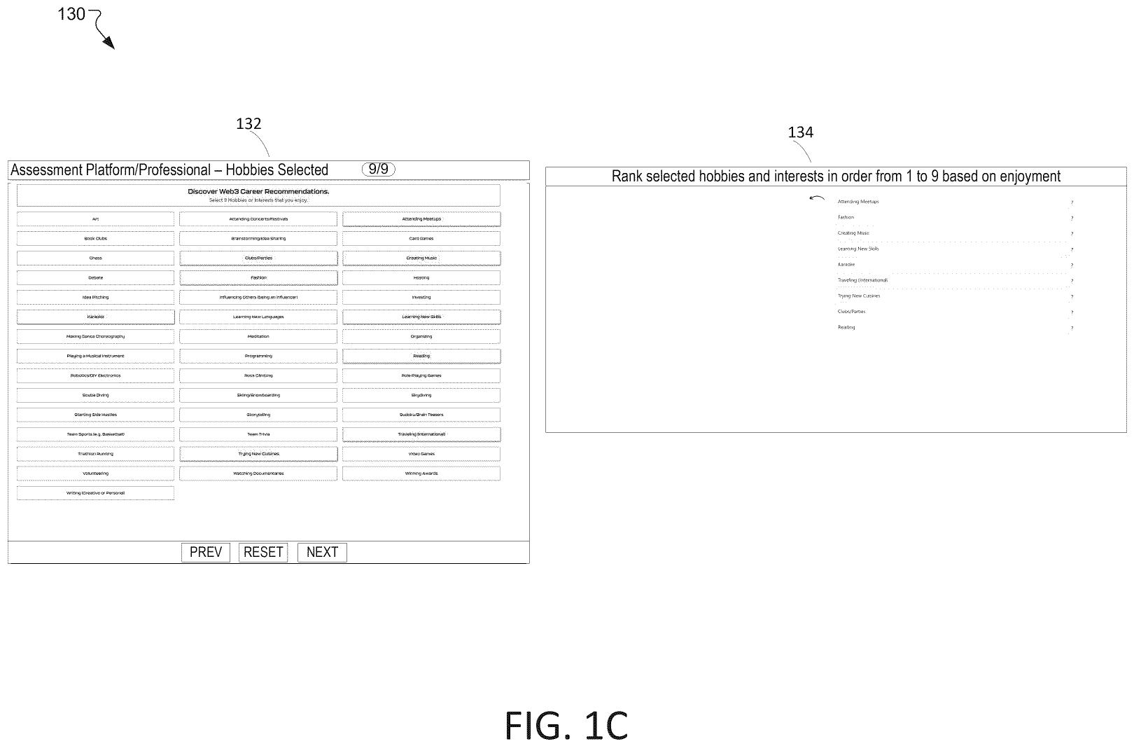

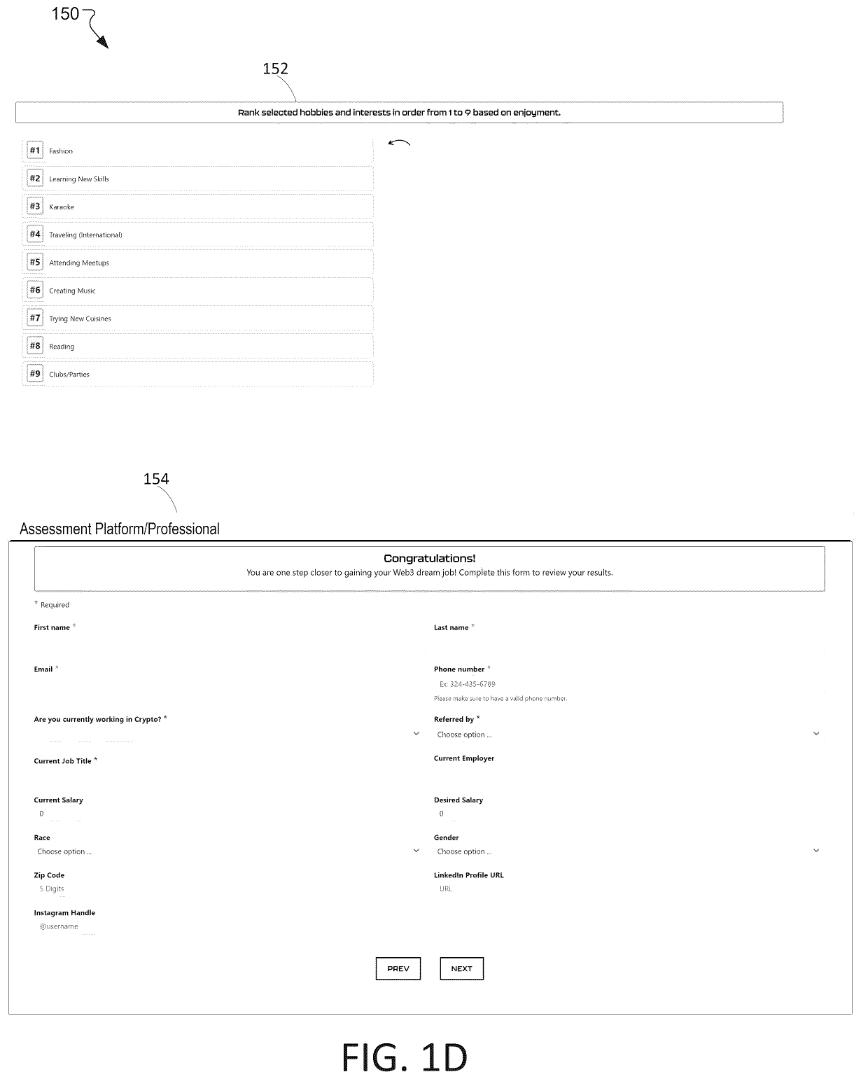

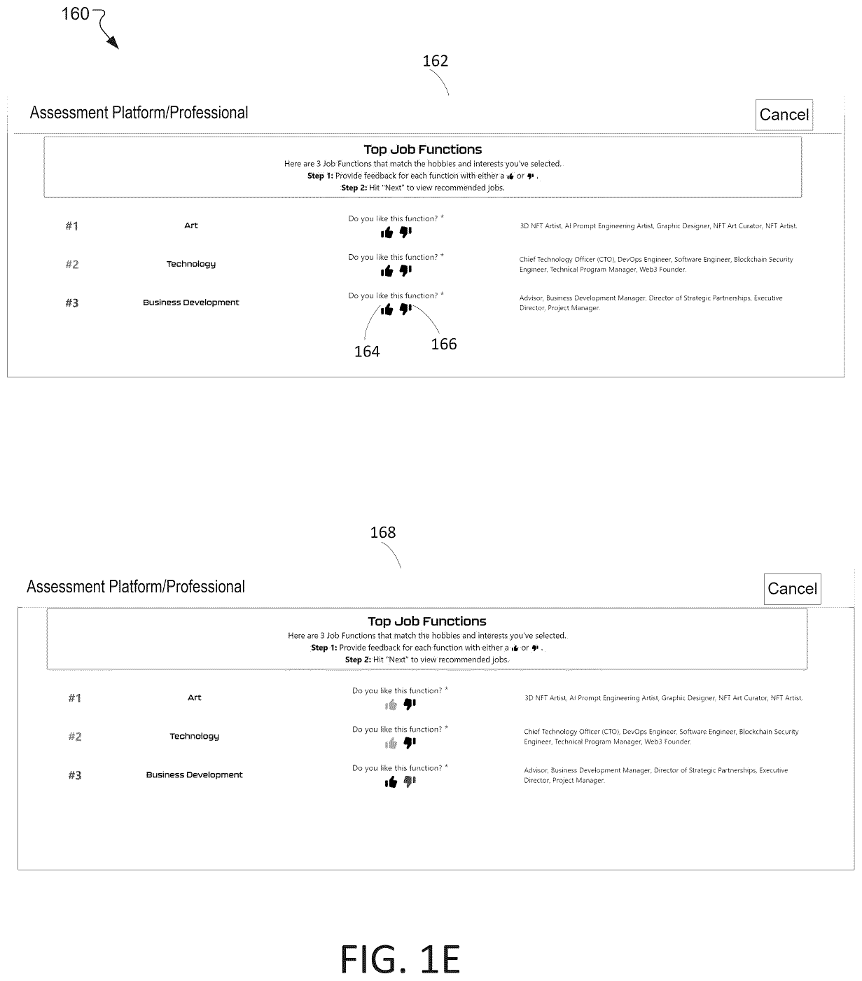

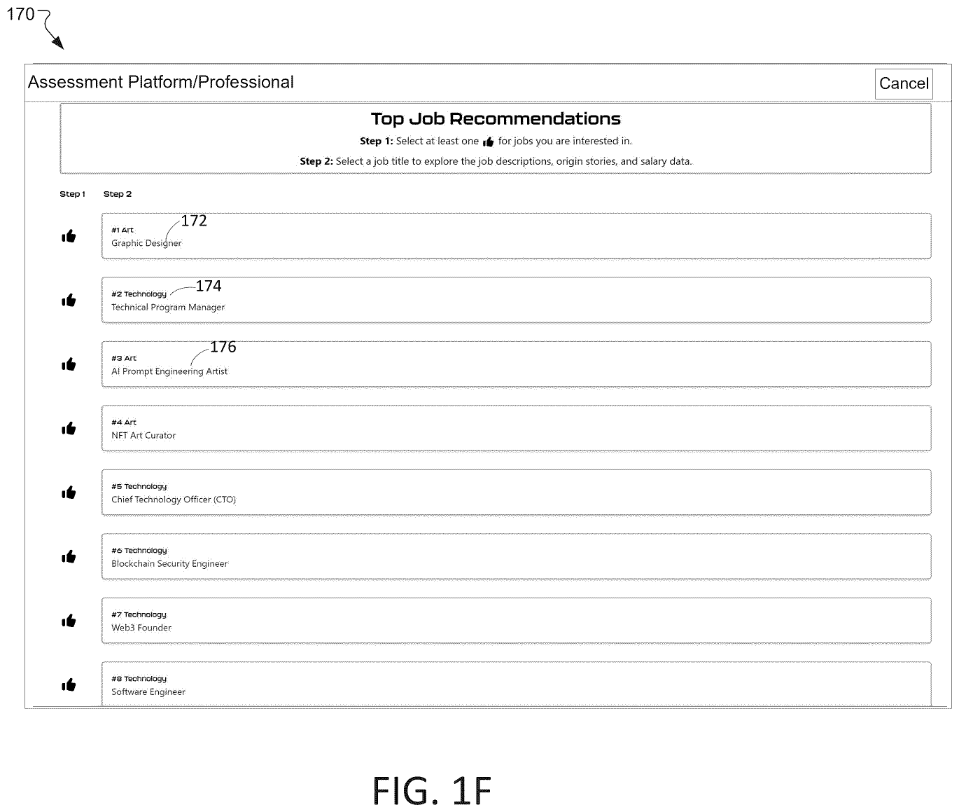

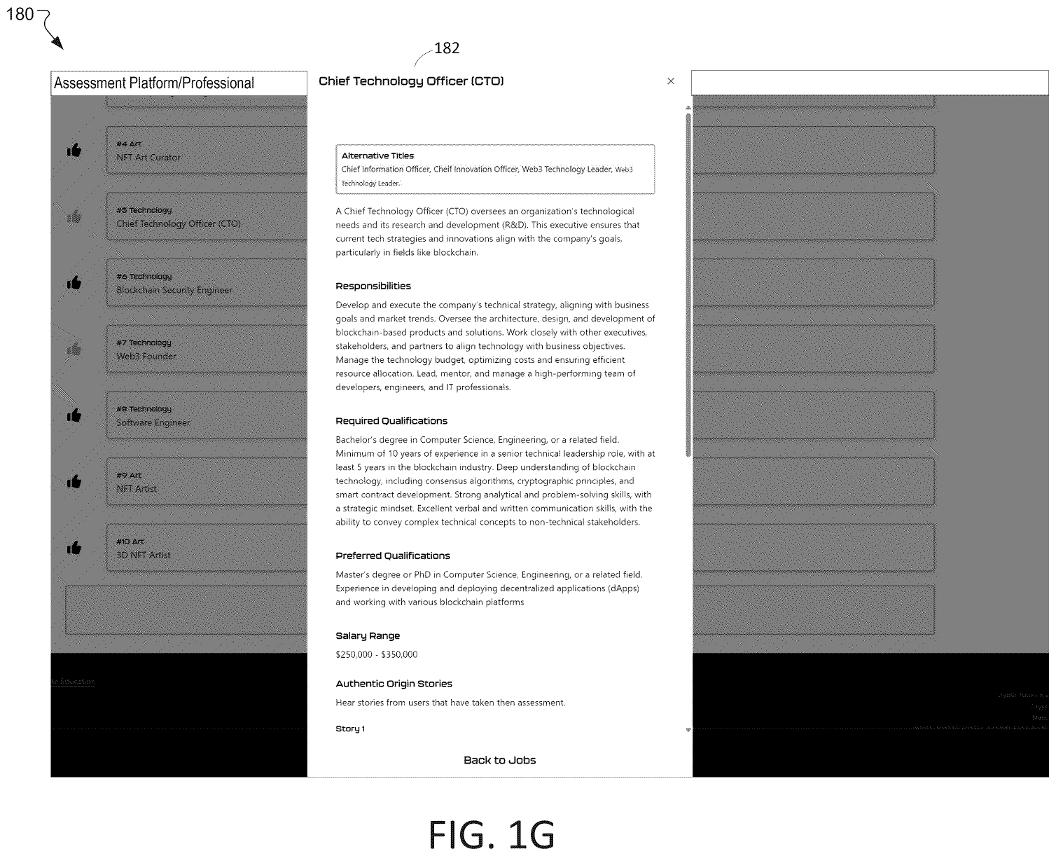

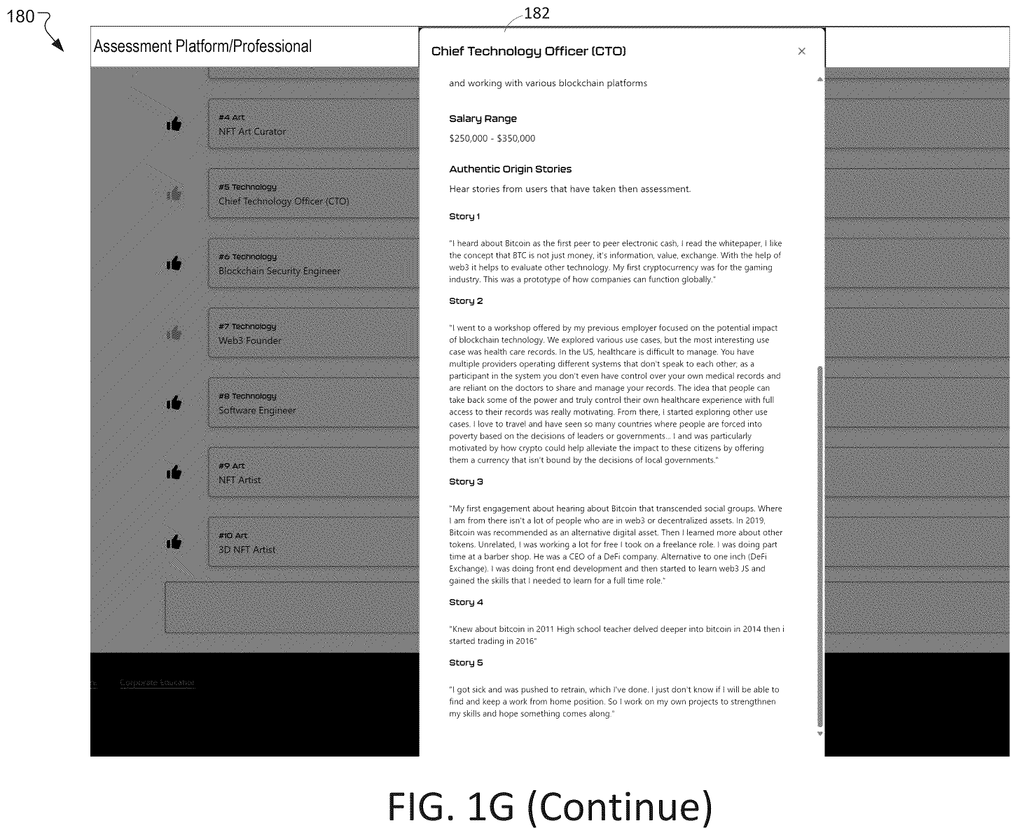

FIGS. 1A-1G illustrate example graphical user interfaces (GUIs) for presenting data (e.g., survey, recommendations) to users and/or receiving user responses. In some embodiments, through these interfaces, user hobby selection and survey data segregation may be performed. In other words, users can select and rank a sample of hobbies from a predefined population, and survey data relevant to the use case (e.g., job function) may be used.

FIG. 1A includes a GUI 100 where a user can begin a career assessment. In the illustrated example, this GUI may be an initial page on a career path site for assessment as a web3 professional. To begin, users may click a button 102 to sign in the disclosed platform. This may lead users to dashboards to collect data, perform tasks, and/or view status of learning paths, qualifications, etc. In FIG. 1B, the disclosed system provides options to the user in GUI 120, where the user can select if he/she is a student 122, a professional 124, or a manager 126. Depending on the user's selection, the disclosed system may change information collected and displayed to the user accordingly, for example, through different dashboards illustrated below.

Upon the user selection of a student or professional, the disclosed system generates and presents GUI 130 of FIG. 1C to the user such that the user can select and rank a sample of hobbies from a predefined population. This is the part of the assessment where the user's top N hobby or interest data is collected, where N is a positive integer. The hobbies can be anything that a candidate (e.g., a web3 professional) may be interested in, not merely activities related to the specific career (e.g., web3 career development). For example, the hobbies can include learning new languages, learning new skills, attending meetings, watching documentaries, skiing/snowboarding, trying new cuisines, traveling, mastering debate, performing meditation, volunteering, writing, etc.

In practice, there may be a large number of hobbies associated with certain types of job positions, making it difficult for a user to efficiently identify and select the hobbies he/she is most interested in. Traditional systems typically display hobby icons alphabetically (e.g., by name, type, etc.), resulting in inefficient navigation, especially when the number of available hobbies is large. To address this, the disclosed system may automatically organize icons of hobbies so that the most frequently selected hobbies by many users (e.g., over a threshold percentage of total users) are positioned in a distinct location (e.g., the first location in the first row and the first column, or the first row). This position is distinct because the user can easily access it (e.g., no need to scroll down). In some embodiments, the disclosed system automatically tracks each hobby selection made by users and determines the number of selections of each hobby icon. Based on this determination, the disclosed system may rearrange icons of hobbies on GUI 130 by moving the most selected hobby icons to a prominent or easily accessible location position within the GUI, thereby improving the user interface for electronic devices as well as streamlining the user selection process.

In the example illustrated in 132 of FIG. 1C, there are a total of 43 hobbies and interests that users can choose to obtain their top 9 hobbies. Once the hobbies/interests are selected, the disclosed system may instruct the user to rank the hobbies in 134 (e.g., based on the level of enjoyment each user feels), as shown in GUI 150 of FIG. 1D. The order of the hobbies selected by the user is shown in 152 of FIG. 1D. After the user ranks the hobbies, the user is directed to 154 to finish the sign-in or start process. As depicted, the user is prompted to provide contact information (e.g., name, email address) and demographic information (e.g., university attended, zip code).

It should be noted that the specific numbers (e.g., 43, 9) are described herein merely for exemplary purposes. A different number M of hobbies or interests can be presented to a user. The user can rank the M hobbies from the highest to the lowest, and the top N hobbies (where M>N) are displayed. In some embodiments, however, N may not fall below a specific threshold number (e.g., 9 hobbies). The disclosed system may determine this threshold number based on the user responses. For example, the most frequent number of hobbies (the mode) chosen among web3 professionals in the original web3 professional survey was nine. In some embodiments, the disclosed system may also set this threshold number using other statistical measures, such as the average or median number of hobbies selected across the survey.

A minimum threshold N is configured to balance user engagement with system reliability. Using a statistically informed threshold helps ensure sufficient user input for accurate recommendation generation, while also preventing user fatigue. For example, if the median or average number is greater than the mode or most frequent number, the disclosed system may default to use the mode as a threshold hobby number. This helps reduce cognitive load and avoid overburdening users with excessive hobby choices. Conversely, the disclosed system may adopt the median or average number as the threshold number to enhance the depth of user profiling. This dynamic thresholding improves both user experience and the robustness of the disclosed recommendation system.

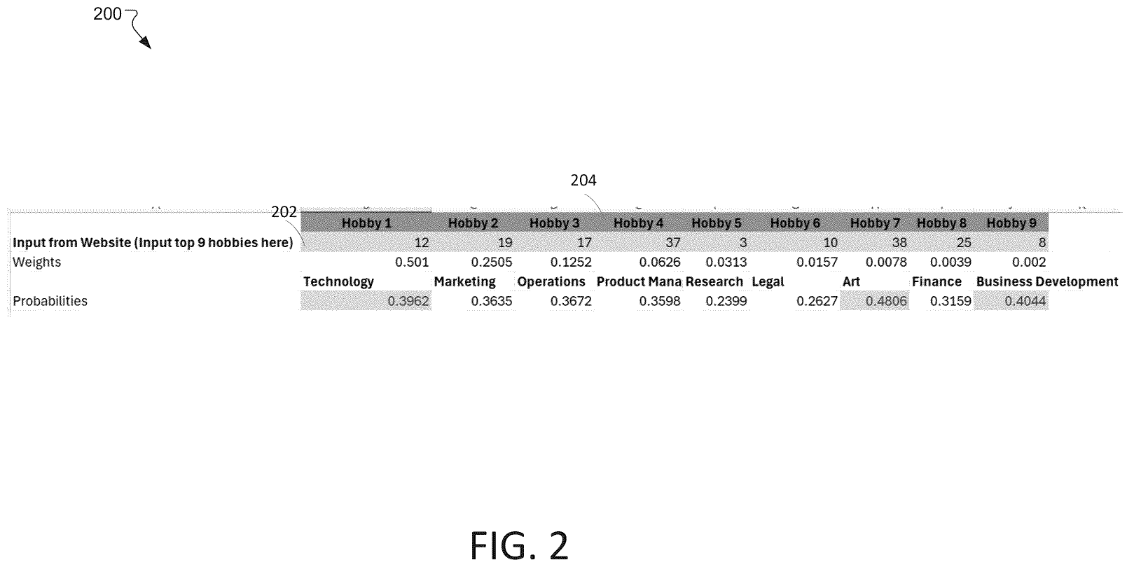

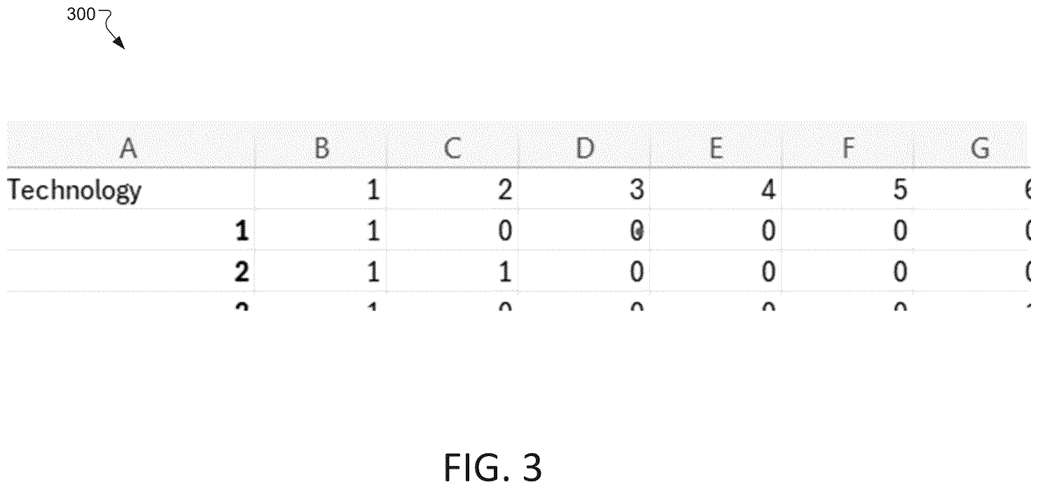

FIG. 2 illustrates an exemplary table 200 showing the back-end processing of the disclosed system upon receiving user input. In some embodiments, the disclosed system may assign a unique identifier (ID) (e.g., 1, 2, 3 . . . 43) to each hobby used in the calculations. In some embodiments, the hobbies used by the disclosed system for probability calculations are the top 9 hobbies inputted by users. In table 200 of FIG. 2, the top 9 hobbies from a specific user are hobbies 12, 19, 17, 37, 3, 10, 38, 25, and 8 in row 202, which, respectively, correspond to Hobby1 through Hobby9 in row 204. These hobbies are arranged in a decreasing ranking order from left to right. That is, “Hobby 1” is ranked highest (e.g., “most enjoyable”), and “Hobby9” is ranked lowest by the user. In the illustrated example, the highest-ranked hobby or “most enjoyable” hobby by the user is hobby 12 in row 202, which corresponds to “Fashion” in the hobbies options (as included in 132 of FIG. 1C). Once the input (e.g., top 9 hobbies) are collected from a user, the disclosed system may perform dynamic, real-time recommendation determination and display the resulted recommendations (e.g., job functions) to the user. The other information shown in FIG. 2 (e.g., weights, probabilities) will be detailed below with reference to FIGS. 3-5, where the algorithms applied to recommendation determination are discussed. The recommendations generated and presented to users are shown in FIGS. 1E and 1F.

Referring back to FIG. 1E, where the generated recommendations of job functions are displayed to a user in GUI 160. The disclosed system displays in 162 the top K (e.g., K=3) recommended job functions generated for the user. Along with these recommendations, the disclosed system may also display an option “thumbs down” 164 or “thumbs up” 166 for the user to provide feedback about the recommended job functions. The job functions that a user likes or dislikes (e.g., thumbs up or down) are shown in 168. Additionally or alternatively, a specific symbol may be provided to users to express their feelings about the job title. It should be recognized other types of feedback may be received from users and analyzed by the disclosed system. In some embodiments, the disclosed system may track the feedback (e.g., thumbs up, thumbs down) about the recommended job functions and titles from users, and utilize this user feedback to improve the accuracy of recommendations.

Upon receiving a positive response (e.g., thumbs up) about a job function from a user, the disclosed system may provide potential job matches that the user can explore. FIG. 1F illustrates example job matches 170 presented to a user. Here, the user provides a thumbs up to the finance job function, and, accordingly, three job matches shown in 172, 174, and 176 are generated and presented to the user for facilitating the subsequent job description for the user. It should be noted that more or less job recommendations (e.g., 10 job titles) may be presented to the user (e.g., along with options of thumbs up and thumbs down) depending on the system and/or user configuration.

The disclosed system may provide tiered information about the job the user is interested in. For example, responsive to the user selecting a recommended job (e.g., 172, 174, or 176 in FIG. 1F), the disclosed system may generate a user interface 180 in FIG. 1G to present a job description 182. In this example, the job description corresponds to the position of chief technology officer (CTO). Job descriptions for any roles of interest to a user (e.g., web3 founder, graphic designer) may likewise be presented to the user. In some embodiments, a job description may include required skills, salary information, user profiles (e.g., LinkedIn profile), and authentic information (e.g., authentic origin stories about how a user started in Web3). In some embodiments, once the user selects the job description 182, the disclosed system may proceed to the next tier, for example, to pop up another interface to provide a specific symbol (not shown) to confirm that the user does like the recommended job. In some embodiments, the disclosed system may track the user's activities (e.g., clicking history) associated with the job recommendations and analyze which job the user is interested in (e.g., based on checking the job titles the user opened) to further improve the recommendation system.

### Recommendation Algorithm

In some embodiments, for each category of job function, the disclosed system may perform a combination of bootstrap and Monte-Carlo simulation based on the received data (e.g., web3 survey data from survey participants) within that particular job function. In some embodiments, the disclosed system may also incorporate Bayesian methodology to calculate the probability of being in a particular job function. Typically, the disclosed system employs the Monte Carlo algorithm to initially match users (e.g., students) to potential career paths (e.g., job functions) based on their hobbies and interests. These preliminary matches are then refined by incorporating each user's academic background, enabling the disclosed system to identify the most relevant job functions and, ultimately, the specific job titles that best align with both their personal interests and educational qualifications.

In some embodiments, bootstrap sampling may at least include operations of random selection and hobby comparison. Within each category (e.g., a job function), the disclosed system may randomly select survey entries (e.g., hobbies) using a bootstrap method, allowing for the same entry to be randomly selected multiple times. The disclosed system may then compare the hobbies of each randomly selected entry to the user selected and ranked hobbies.

Based on the hobby comparison, the disclosed system may further perform binary response calculations. In some embodiments, binary response calculation may include operations of match evaluation and sum-product calculation. For match evaluation, based on the hobby comparison result, e.g., whether a randomly selected hobby matches the user's selection, the disclosed system may compute a binary response for each hobby. The binary responses may then be multiplied by corresponding weights to obtain an output between zero and one. In some embodiments, the disclosed system may calculate a weight (e.g., using steep exponential decay as described below with reference to FIGS. 3-5) or predefine a weight for each response. In some embodiments, the weighting schema and/or decay models may be modified to maintain recommendation stability as collected data evolves.

In some embodiments, the disclosed system may use a Monte Carlo simulation based on bootstrap sampling to calculate a probability for each category (e.g., job function). The probability indicates how likely a user's hobbies may align with a particular job function. For example, the disclosed system may perform a trial execution by repeating the process 10,000 times within each category, following the Monte Carlo method. In some embodiments, the disclosed system may calculate an average from the outputs of the Monte Carlo simulation as a probability for each category. In some embodiments, the disclosed system may rank the calculated probabilities for each category to generate a final recommendation output and display the output to the user, (e.g., as shown in FIGS. 1E-1G).

### Bootstrap and Monte-Carlo Simulation

In some embodiments, the disclosed system may use Monte Carlo to solve the recommendation problems through numerous simulations (e.g., 10,000). This approach may reach the same answer that other analytical solutions (e.g., Black Scholes equation) may achieve, but with significantly reduced complexity and processing time. The disclosed system may also use survey data to process data in an efficient way.

The disclosed system may be applied in a variety of areas. For example, when a student is applying to college, the disclosed system (e.g., a user experience module) may identify a number of hobbies and interests (e.g., nine hobbies and interests) that the student enjoys for fun. The disclosed system (e.g., an assessment module) may then compare the identified hobbies and interests with those of the largest web3 population by function and job title to determine how likely the student's hobbies may align to a job function/title. In some embodiments, the output of the disclosed system may be measured based on the student's responses, for example, whether the student is happy with the result, whether the student increased their knowledge of web3 jobs, etc.

It should be noted that the disclosed system supports unlimited categories of hobbies and interests. In the example of job matching, this means that the hobbies and interests do not imply any job. In contrast, most other career assessment systems require such implications. That is, other assessment systems would ask a student “do you want to represent a client in a courtroom” to imply a lawyer. This could be problematic since students often do not know what they like until they try it. It is therefore unrealistic to ask a student any interests that are implied or interests that the student has never tried. The disclosed system provides a realistic and effective approach to improve recommendation processes with unlimited categories of hobbies and interests.

In some embodiments, the disclosed system may further establish a proof mechanism for a general knowledge web3 portfolio. For example, after a student is matched to the job, the disclosed system may require the student to show proof that he/she has the required skills for that job. In some embodiments, a certain number of projects (e.g., three projects) may be required to prove the quality of the student's skills, and this cannot be produced through artificial intelligence (AI).

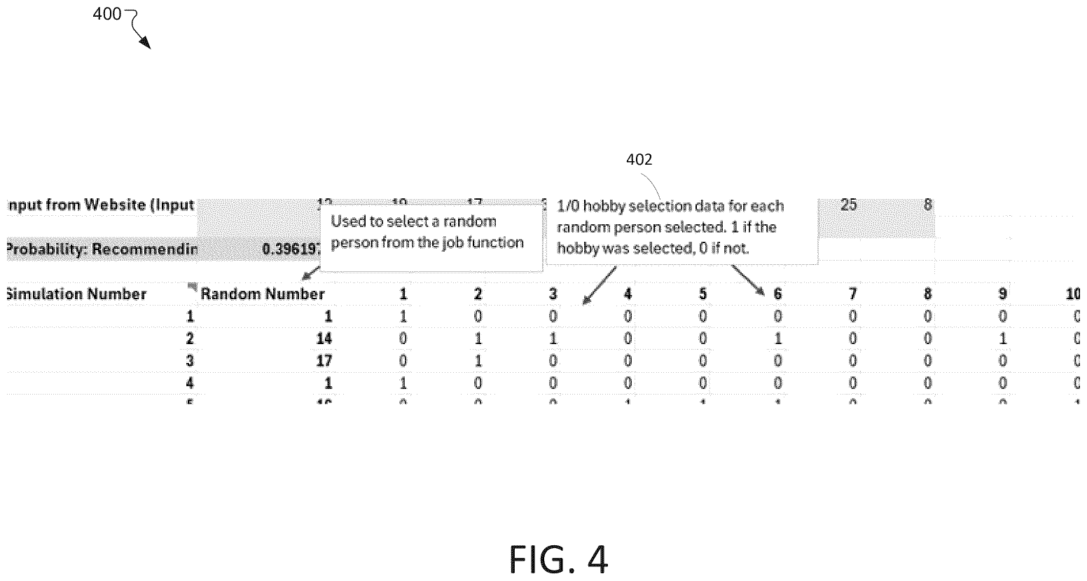

FIG. 3 illustrates exemplary user hobby data for a job function. Using a “Technology” job function as an example, the survey data is restructured and shown in table 300 of FIG. 3. In some embodiments, the disclosed system restructures the survey data so that the user in the technology group has a zero or one entry for each hobby. In some embodiments, the disclosed system may restructure the data by performing a hobby comparison between the hobbies of each randomly selected entry and the ranked hobbies by the user and calculating a binary response for each hobby. For example, if the user participates in Art as a hobby, the disclosed system may assign a “1” to this specific user regarding this hobby. Otherwise, this user will be assigned a “0” in the entry of this hobby. The binary response for each hobby is shown in 402 of FIG. 4.

Based on the data restructured from the survey data within the “Technology” job function, bootstrap sampling, for example, random selection may be performed. In some embodiments, the disclosed system may randomly select the entries within the job function (e.g., entries in table 300 of FIG. 3). The selection may be performed with replacement, i.e., with the possibility of selecting the same entry multiple times. In this way, meaningful probabilities can be generated even with repeated entries.

In some embodiments, the disclosed system may run multiple random samplings of the data (i.e., Monte Carlo simulation). This allows the disclosed system to collect new data without altering the algorithm. In some embodiments, the disclosed system may perform 10,000 trials to ensure robust results. FIG. 4 illustrates an example table 400 including simulation data. As depicted, if the hobby selection from a user changes, the disclosed system may adjust the ranking accordingly.

### Bayesian Approach

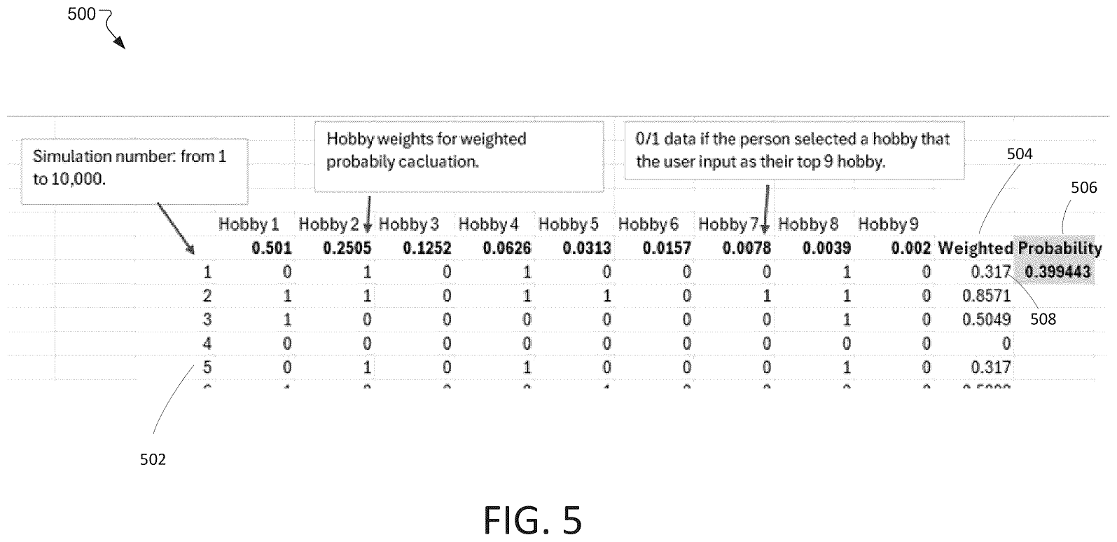

In some embodiments, the disclosed system applies a Bayesian approach to calculate probabilities of a user being in a category (e.g., Technology job function). FIG. 5 illustrates an example table 500 for probability calculation.

Each row of table 500 represents relevant data in one simulation, where the simulation number is shown in column 502 (i.e., five simulation data are shown in table 500), the probability calculated from each simulation is shown in column “weighted” 504, and in-between 502 and 504 are the binary responses determined for each hobby match (i.e., zero or one). To obtain the probability from each simulation in column 504, the disclosed system may first determine a weight for each of the top 9 hobbies and calculate a sum product (i.e., in 504) of the binary responses with the determined weights. The disclosed system may then compute an average over the 10,000 trials to obtain a final probability for each category, e.g., the probability shown in 506. A category can be a job function.

For example, to get the weighted probability of 0.317 for the first simulation in 508, the disclosed system may compute as below:

$$( 0 \times 0.501 ) + ( 1 \times 0.2505 ) + ( 0 \times 0.1252 ) + ( 1 \times 0.0626 ) + ( 0 \times 0.0313 ) + ( 0 \times 0.0078 ) + ( 1 \times 0.0078 ) + ( 0 \times 0.002 ) = 0.317$$

It is critical to obtain the weights including 0.501, 0.2505, 0.1252, etc. In some embodiments, the disclosed system may use a steep exponential decay to calculate these weights. In some embodiments, using this model, the disclosed system may configure that the first hobby has the highest weight and each subsequent hobby has a weight that is half of its predecessor. These weights are normalized such that their summation is one.

The disclosed system may calculate each weight for the hobbies based on a reduction factor that is typically less than one. In some embodiments, the disclosed system sets this factor to be 0.5, and thus each subsequent weight is half of its predecessor. For example, a steep exponential decay model may be used to compute the weights. First, a decay constant (λ) (e.g., λ=0.693) may be chosen for a steep decay, and each weight wᵢ (i=1, 2 . . . ) is:

$${w}_{i} = {e}^{- λ ( i - 1 )}$$

Using the above equation, each weight is approximately half of the previous weight. This weight is used frequently for a swift decay rate. Assuming the weights assigned to 9 hobbies are wᵢ (i=1, 2 . . . 9) and w₁=1, then w₂=0.5, w₃=0.25, . . . . Once each weight is obtained, the disclosed system may normalize the weights to ensure the total sum of the normalized weights is one (e.g., dividing each weight by the total weight). For example, the normalized weights can be w₁=0.501, w₂=0.2505, and so on. The normalized weights are then applied in the Monte-Carlo simulations.

Based on the Monte Carlo simulations and the weights determined for each hobby, a final probability is calculated, e.g., 0.3999443 in 506 of FIG. 5. It should be noted this final probability is associated with the category of “Technology” job function because the simulation and probability calculation in FIGS. 3-5 are based on the hobby data received from a user within this specific category.

Similar simulation and probability calculation for the user may be performed for other categories such as marketing, operations, product management, research, legal, art, finance, etc., based on the hobby data received from the user. In some embodiments, the disclosed system may rank the probabilities associated with different categories and determine the job functions having the top M (e.g., M=3) probabilities as recommendations to the user. For example, as depicted in 162 of FIG. 1E, the top 3 recommendations of job functions shown to a user are art, technology, and business development. However, if the user is a student, the top three functions may be recommended and presented to the student unless one or more job functions do not correlate with the student's major. In such a case, the disclosed system may replace the lowest function to reflect the major, thereby ensuring a job recommendation to match the major at all times.

In some embodiments, the disclosed system may also determine the category having the highest probability (i.e., the most likely group that the user belongs to), and display the icon of this category in a position that is most easy to access by users (e.g., the leftmost position as shown in 162 of FIG. 1E).

### AI-Based Qualification Journey

Disclosed herein is an innovative real-time recommendation tool that bridges the gap between users' interests/hobbies and emerging careers across both web3 and non-web3 industries. The disclosed system serves a wide range of users, including students, professionals, hiring managers, and administrators, based on identifying transferable traits that indicate potential alignment with specific career paths. By detecting talent that can effectively transition into a specific industry, the disclosed tool not only enhances awareness of career opportunities in the industry for certain users (e.g., students, professionals) and guides these users through a tailored learning process, but also provides hiring managers with streamlined access to a qualified and adaptable talent pool.

In some embodiments, dashboards customized for distinct user groups, including students, professionals, hiring managers, etc., are deployed. These role-specific dashboards are tailored to user objectives, enabling differentiated experiences within the same corporate portal. In some embodiments, the disclosed system may deploy the dashboards through software applications (e.g., Azure® static web applications) to allow for seamless updated and automatic scaling based on real-time traffic demands. The backend infrastructure may also be engineered to robustly support the interaction between the dashboards and underlying database(s), enabling secure, high-performance data access and real-time responsiveness across user sessions.

While the terms “student dashboard,” “student learning path,” “manager dashboard,” and “hiring manager dashboard” are used hereafter for simplicity and clarity, they are not intended to be limited to students or managers in a strict sense. The “student dashboard” or “student learning path” refers more broadly to the general-purpose dashboard or path designed for any individual, whether a student or a professional, who is engaging in skill development to become qualified for a job, whether at an entry or senior level. Similarly, the “manager dashboard” applies to any user involved in overseeing or participating in the hiring process, regardless of their formal title or role within an organization. The “hiring manager dashboard” may be used by any user responsible for recruitment-related activities.

### Student Dashboards

FIGS. 6A-6C illustrate exemplary GUIs that enable users to receive personalized recommendations, explore career paths, and track their progress toward becoming qualified. In some embodiments, the personalized recommendations may include AI-generated output recommendations. In other embodiments, the recommendations may include dating recommendations. FIGS. 6A and 6B illustrate top suggested job titles, helping a user narrow down to a final job choice. FIG. 6C shows a homepage dashboard, which updates to reflect the selected top job.

As discussed above, the disclosed system may employ a recommendation algorithm (e.g., Monte Carlo algorithm) to match a user's hobbies and interests with potential job functions, and refine this matching using additional user context (e.g., academic majors, uploaded resumes) to generate accurate and personalized recommendations that best align with the user's hobbies/interests and academic backgrounds. FIG. 6A illustrates top job recommendations presented to a user (corresponding to the GUI 170 previously discussed in FIG. 1F). The user (e.g., as student) may select one or more jobs of interest (e.g., using the thumbs-up icon) and further choose a specific job title to view its corresponding description (e.g., as shown in FIG. 1G). After making selections, the user can proceed by selecting the “Continue” button 602, which directs the user to the interface shown in FIG. 6B. Alternatively, the user may select the “Go Back” button 604 to review the job functions.

Using GUI 630 of FIG. 6B, the user can choose his/her favorite job. In the illustrated example, four refined job recommendations 632 are presented to the user, where the user can choose a role (e.g., chief technology officer (CTO)). Upon making the selection of a job title, the user is directed to a personalized student dashboard 650 in FIG. 6C. In the example of FIG. 6C, the dashboard is displayed for a user named yumiko, identified as a “Professional” in 652, with the selected job title of CTO in 654. The user is provided with immediate access to curated opportunities, including more than 60,000 jobs and internships (e.g., in 656, 658) aligned with a CTO's chosen path.

Importantly, student dashboard 650 is an interactive front-end interface that acts as a central hub for students/learners, guiding the learners through personalized qualification paths. In some embodiments, a student dashboard is powered by an agentic AI system that uses a natural language interface to interact with students and respond to their selections in real time. Once a student selects a specific job title, the AI agent can be triggered to initiate a data-driven learning journey. This initiates a rule-based or machine learning-powered decision engine to create a customized learning journey using user data (e.g., assessment results, resume, LinkedIn) associated with the user. In some embodiments, this journey may be constructed through a skill gap analysis algorithm that compares the student's current skill set with the competencies required for the selected role, automatically generating a tailored curriculum.

In some embodiments, the disclosed system may also use the AI agent to perform task scheduling and notification. For example, event-based or time-based triggers may be configured to send reminders and prompt project completions for users. In some embodiments, the disclosed system may use a reactive front-end framework (e.g., SvelteKit) to manage UI state and progress tracking (e.g., 660, 662) in real time, providing a seamless user experience.

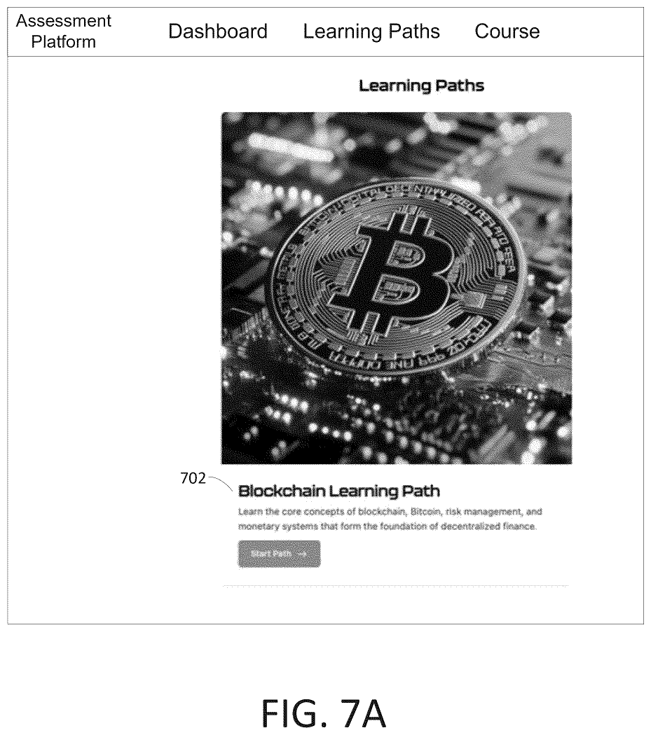

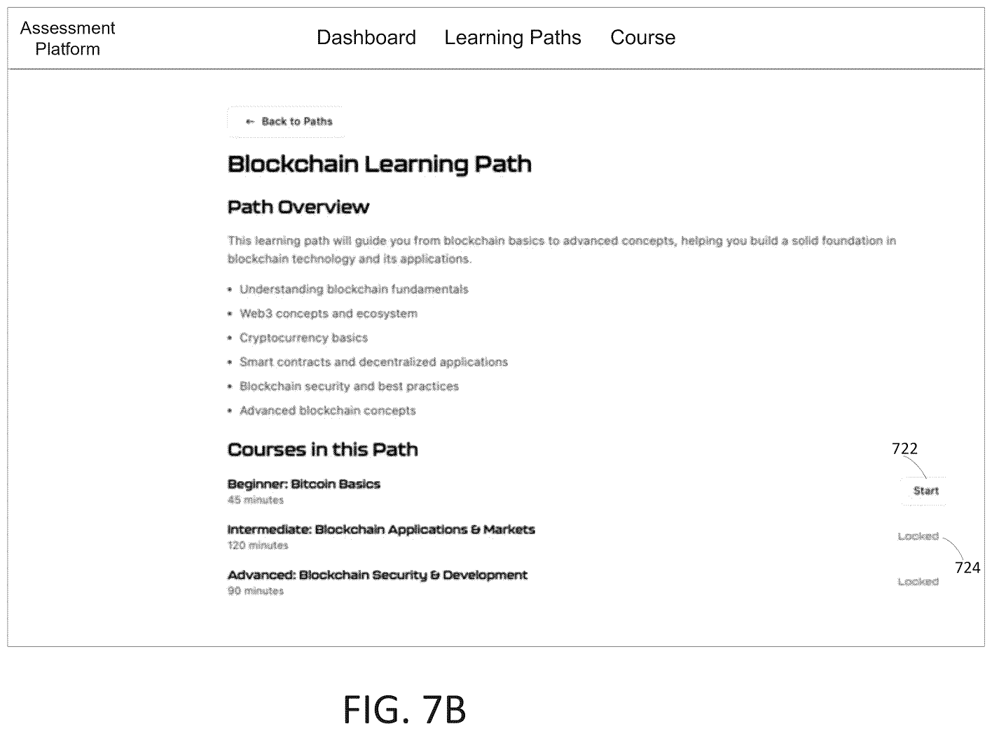

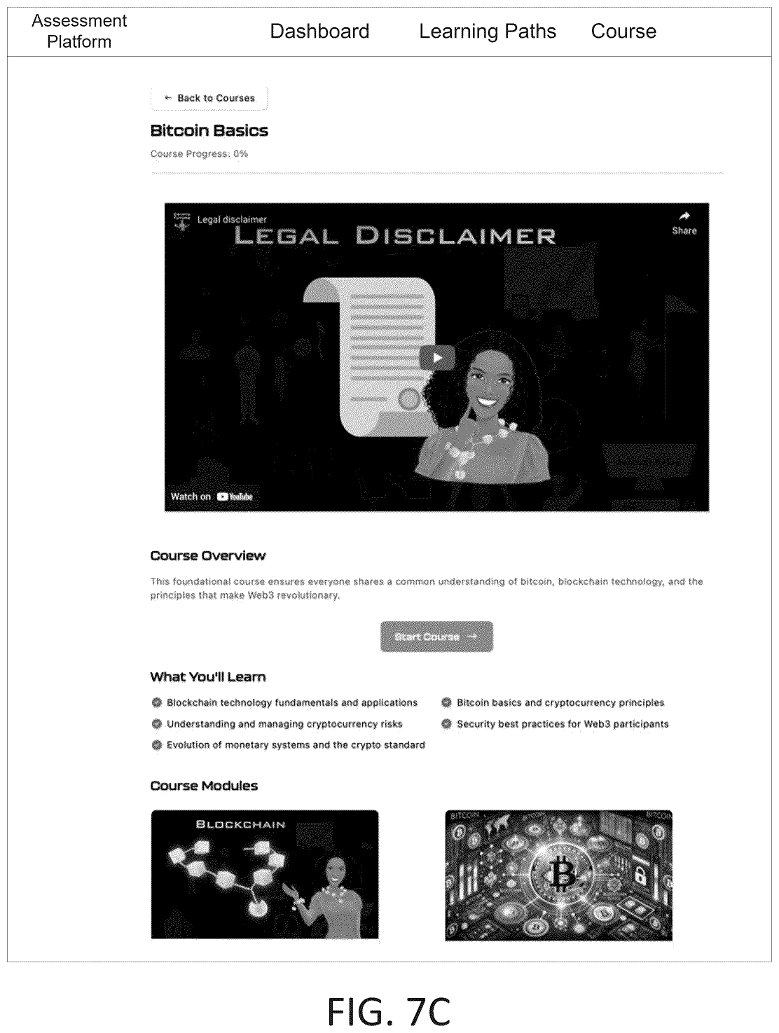

FIGS. 7A-7C illustrate exemplary GUIs providing a student learning path. The learning path includes personalized learning tracks tailored to a user's current skills and desired job role. In this example, this path is a blockchain learning path 702 as shown in FIG. 7A. Specifically, a sequence from beginner to advanced topics associated with the blockchain learning path 702 is illustrated in FIGS. 7A-7C. Each stage includes unlocked or locked courses based on user progress, as respectively shown in 722 and 724 of FIG. 7B. While the user is increasing his/her blockchain knowledge through a clearly defined career path, talent insights, job qualifications, and other features (e.g., salaries) to better understand how to qualify for a real-world career is also presented in one or more GUIs of the student dashboard.

To generate a learning path, the disclosed system may assess a user's submitted or inferred skills and compare the skills against a structured skill taxonomy mapped to specific job titles. Based on the identified skill gaps, the disclosed system may recommend relevant learning content, such as courses, tutorials, or projects, using relevance scoring methods (e.g., cosine similarity, embedding-based models, etc.). As users progress through the learning path, the disclosed system may incorporate performance feedback, such as completion status, time spent on tasks, and quiz results, to dynamically adjust and reprioritize the next set of recommended learning activities. In some embodiments, one or more AI models are trained using the collected data (e.g., user skill profiles, real-time industry data, etc.) to generate and adapt learning paths. The AI model(s) may also be retrained continuously to ensure that the recommended paths remain relevant and effective (e.g., based on user feedback and learning progress).

The agentic AI is activated to guide a user (e.g., a student) throughout his/her custom, multimodal learning journey, which is tailored to the user's learning style, interests, and existing skills. In some embodiments, the agentic AI functions as a proactive assistant, retrieving and delivering relevant courses/assignments, reminding users to complete assignments, recommending jobs and projects, and sharing professional references.

The agentic AI performs multimodal personalization. For example, the disclosed system may use the AI agent to track user interactions, such as page views, video engagement, and assessment activity, to generate timely follow-ups and personalized prompts for a user, ensuring that the user remains on track toward his/her selected career goal. In some embodiments, one or more user performance metrics representing the first user's engagement, completion, or assessment outcomes of the personalized learning path are determined. The AI agent may adjust the educational content in the learning path based on the user performance metrics. The AI agent may also assess the user's learning preferences (e.g., visual, reading-based, or hands-on practice) and adjust the format of learning materials accordingly to enhance comprehension and engagement. In some embodiments, the disclosed system may also construct a job seniority map to inform users of the steps needed to reach an advanced position (e.g., chief financial officer).

### Manager Dashboards

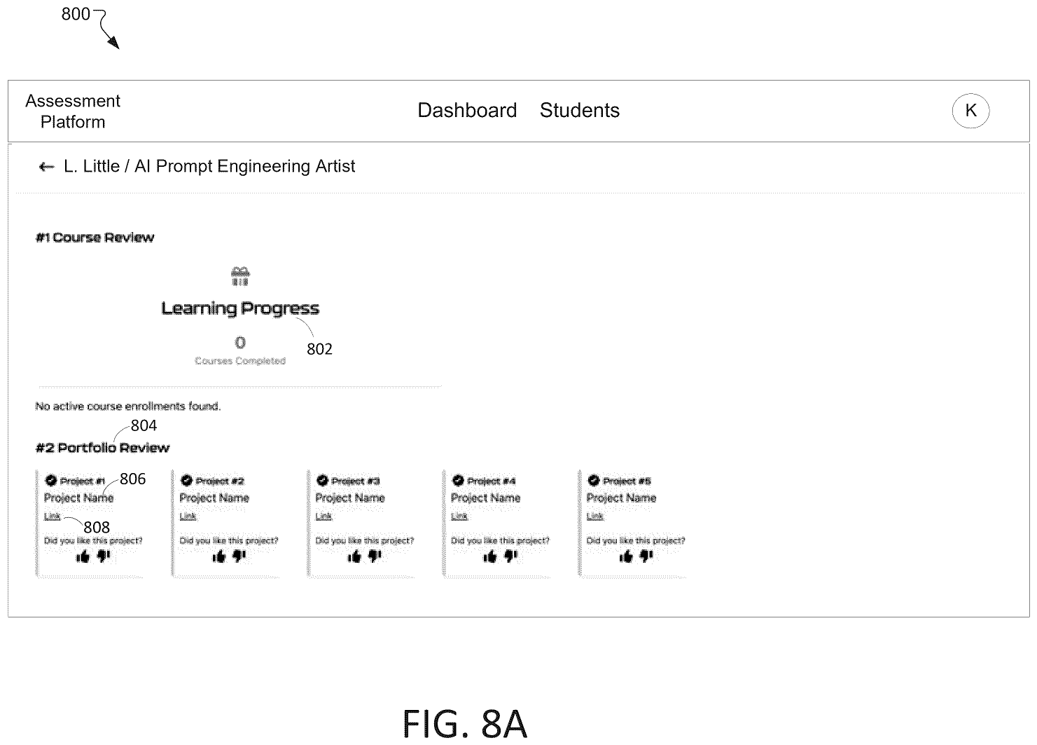

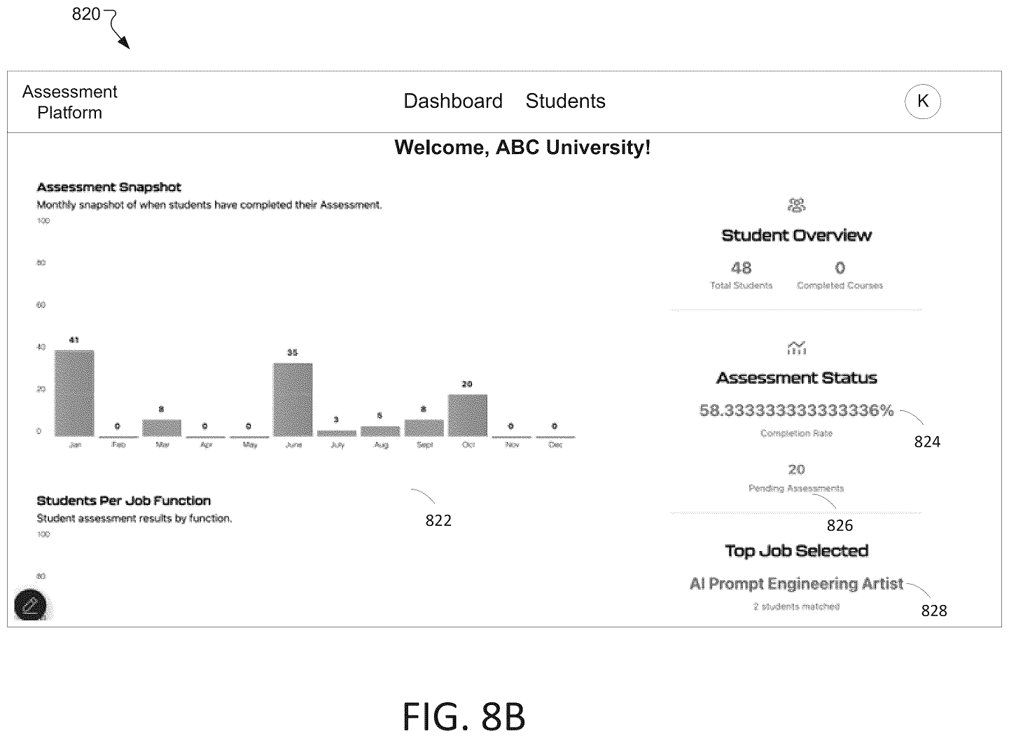

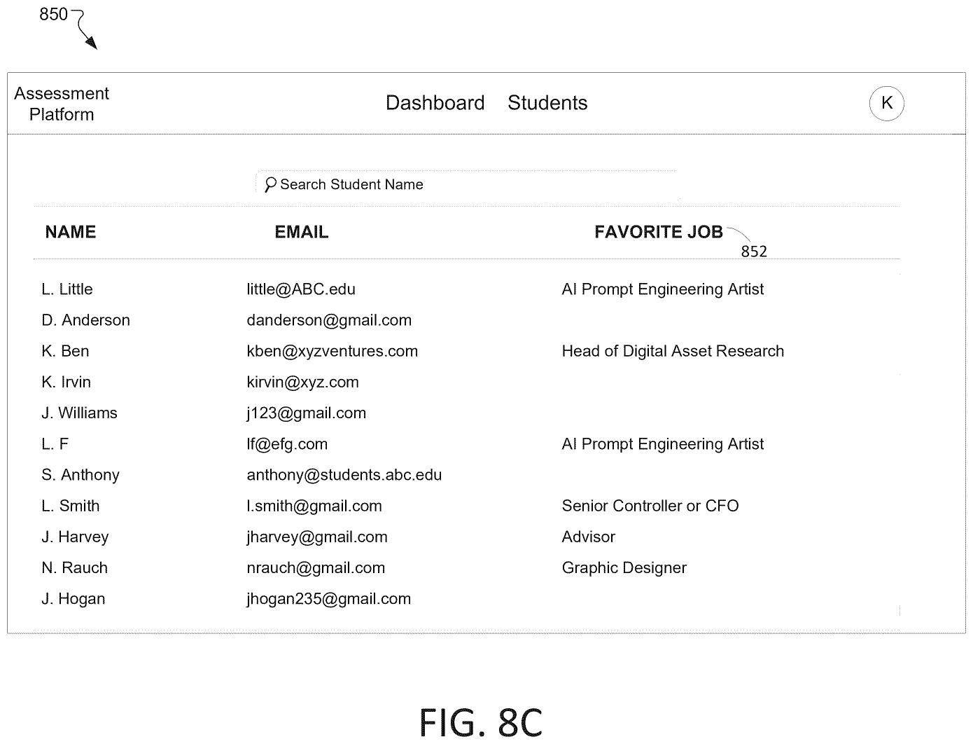

FIGS. 8A-8C illustrate exemplary dashboards for students and managers. Specifically, FIG. 8A illustrates a student dashboard that offers an overview, including course and portfolio status, to facilitate a clear understanding of the student's progress. FIGS. 8B and 8C illustrate manager dashboards that provide access to user (e.g., student) portfolios and oversight of assessment progress and career path selection, enabling effective monitoring of student qualification and progress toward job alignment.

FIG. 8A illustrates a student's view 800 of his/her learning process 802 and portfolio 804. Dashboard 800 is designed to support and guide user/student progress toward qualification. This dashboard offers a centralized interface that displays student portfolios, including validated records of completed courses, certifications, etc. Qualification metrics, such as assessment completion, skill development, and engagement trends, can be monitored and tracked within dashboard 800. This not only provides real-time visibility into user/student progress to enable data-driven academic support but also allows for timely interventions or targeted support when needed.

In some embodiments, dashboard 800 is built on a portfolio management system that aggregates student submissions and validates them as credible proof of skill. Each submission may be versioned and timestamped, ensuring authenticity, traceability, and alignment with current standards. Students may review individual projects (e.g., 806), follow embedded links (e.g., 808), and provide structured feedback. In this way, dashboard 800 may support integrated analytics for identifying trends across student cohorts and is designed to be modular and extensible, allowing for integration with credentialing systems (e.g., blockchain-based), employer dashboards, or external learning management platforms. Blockchian-based credentialing allows each qualification (e.g., associated with a completed course, a passed assessment, or a verified project) to be encoded immutably on a blockchain ledger, making every credential tamper-proof, portable, and verifiable by third parties.

Dashboards in FIGS. 8B and 8C provide managers' institutional-level visibility into user progress and assessment outcomes. For example, dashboards 820 and 850 may be dedicated to providing a comprehensive view of student activity and progress to university administrators. Administrators may view all students who have taken assessments, track when assessments were completed, and review each student's selected career path or preferred job title. This administrative view includes visualized analytics on assessment completion rates, popular job selections, and progress metrics across learning paths, enabling institutions to make informed decisions about program effectiveness and student support strategies. For example, as shown in FIG. 8B, 41 students completed the assessment in January, whereas only 8 students completed it in March (e.g., 822). These results contribute to an overall assessment completion rate of 58.3% in 824, with 20 assessments still pending as shown in 826. Among all the job selections, the most frequently chosen role is “AI prompt engineering artist” in 828. This trend is further supported by the individual job selections shown in 852 of FIG. 8C, where “AI Prompt Engineering Artist” appears as the most selected title.

Overall, the manager dashboards in FIGS. 8A-8C, including graphical summaries, assessment measurement metrics, search tools, etc., allow administrators/managers to track progress across cohorts, identify engagement trends, evaluate the effectiveness of learning pathways, and perform additional tasks (e.g., timely interventions for students lagging), thereby enhancing program management and supporting continuous improvement for recommendation generations.

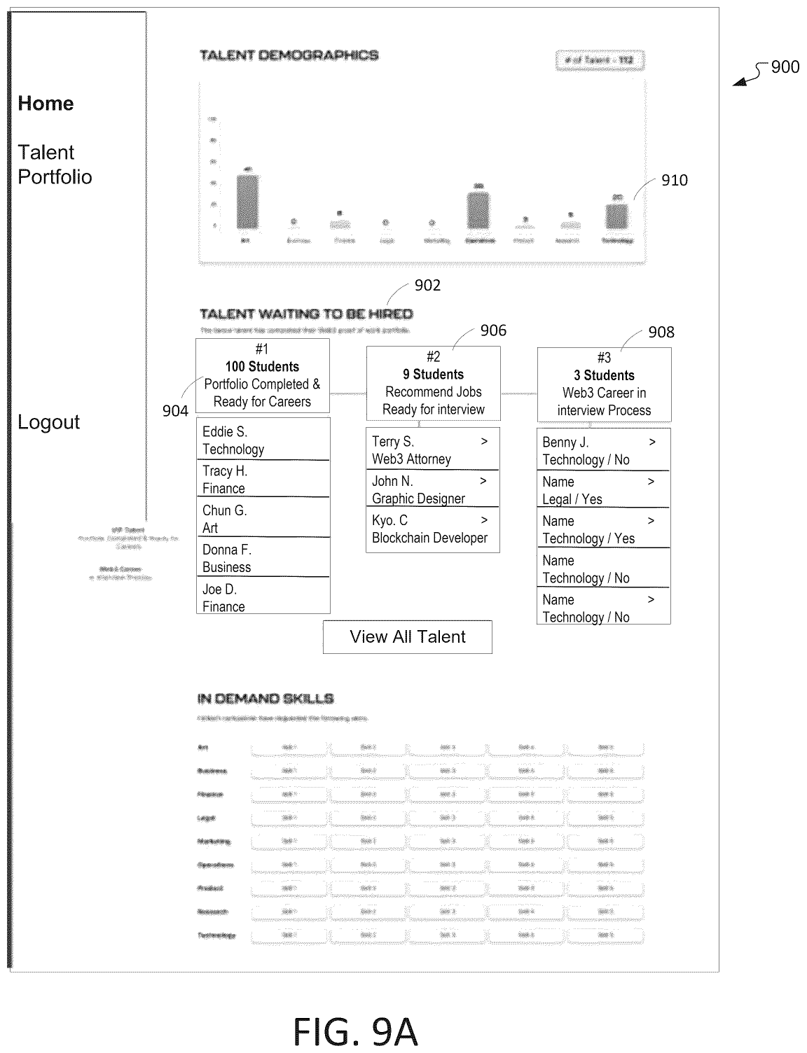

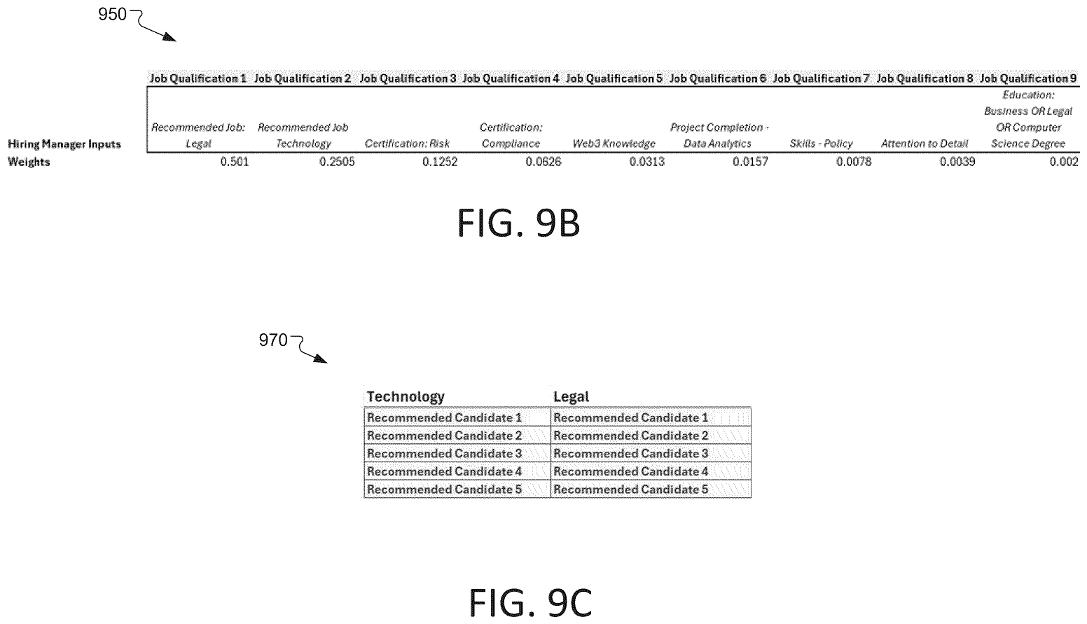

FIG. 9A illustrates an exemplary dashboard 900 specialized for hiring managers. In some embodiments, this dashboard is designed to streamline the candidate filtering process by allowing employers to receive pre-qualified candidates without requiring traditional job applications. Unlike traditional systems that rely on keyword searches or resume-based screening, dashboard 900 leverages verified, portfolio-based validation to assess candidate readiness. When a user (e.g., student or professional) meets pre-defined qualification criteria for a specific job title/role, this user receives proof of qualification and is automatically matched and surfaced to hiring managers in dashboard 900. For example, upon completing verified, project-based work, a user may be designated a specific status (e.g., “VIP status”), which triggers automated visibility to hiring managers within dashboard 900. The underlying filtering logic ensures that only users who have completed necessary assessments, courses, and project work are shown, thereby eliminating the need for manual vetting.

For example, fully qualified users may be placed in a “Talent waiting to be hired” section 902 for displaying to hiring managers. These candidates or talents may then be sorted into distinct categories (e.g., 904, 906, and 908) based on corresponding stages in the recruitment process (e.g., ready for interviews, participating in interviews). Additional information, such as talent demographics in 910, is also displayed to provide hiring managers with deeper insights. This approach removes the burden of sifting through a high volume of unfiltered candidates and ensures that only job-ready, verified talent is presented for consideration. As a result, the disclosed system transforms the traditional application process into a qualification-based hiring model, enhancing efficiency and match accuracy for both employers and candidates.

The disclosed system is also designed for seamless integration, supporting API connections with external job boards and internal applicant tracking systems (ATS). This facilitates efficient data flow and recruitment workflows across platforms.

In addition to viewing pre-qualified candidates, dashboard 900 allows hiring managers to interact with the underlying system to provide real-time hiring needs and talent demand insights. This functionality converts dashboard 900 from a static interface into a dynamic, bidirectional tool. In some embodiments, hiring managers may be prompted to provide valuable hiring intelligence/insights, for example, demand signals about their current and projected hiring requirements for interns and experienced professionals. These insights (e.g., job titles, required skill sets, etc.) may be collected during profile creation and/or through in-dashboard interactions. The disclosed system may then use the insight data to train and continuously refine the qualification and recommendation algorithms. Additionally, the disclosed system may allow the insights to be shared with various types of users (e.g., university administrators, institutional customers, etc.), creating a continuous feedback loop that connects industry needs with academic programming.

By serving as a live data collection tool, hiring manager dashboard 900 plays an important role in maintaining the relevance of the disclosed system to real-world hiring trends. For example, this dashboard may function as a bridge between educational institutions and industry employers, aggregating and validating demand insights to ensure that students and professionals are being trained in the most in-demand skills. The interactive connectivity between employers and educators distinguishes the disclosed system by enabling adaptive learning, industry-aligned training, and employer-driven development.

Once qualification is achieved, the disclosed system automatically applies to relevant jobs on behalf of the candidate, and recommends qualified candidates directly to hiring managers, eliminating the need for manual applications. In some embodiments, the disclosed system implements an algorithm to match candidates to hiring managers based on weighted qualifications, where the qualifications include at least job functions, skills, project completion, education, web3 knowledge, certifications, awards, hackathons, software experience, soft skills (e.g., attention to detail, leadership, adaptability, communication skills, fast learners, etc). Similar to the previously discussed hobby-based matching for students or professional in FIGS. 2-5, a Monte Carlo-based algorithm is also applied to align hiring managers with their top candidate matches (e.g., top five candidates) for each job function.

Hiring managers provide input by selecting and ranking nine preferred qualifications from a predefined list, which then serves as the basis for weighted probabilistic calculations. Each candidate profile in the system is encoded as a binary vector, indicating the presence or absence of each qualification (e.g., “1” shows qualification met, and “0” shows qualification not met). This binary representation enables efficient simulation of match probabilities, allowing the algorithm to generate an ordered set of candidates most likely to satisfy the hiring manager's requirements. For example, a hiring manager may prioritize qualifications such as legal and technology job functions, certifications in risk and compliance, web3 knowledge, completion of data analytics projects, policy-related skills, attention to detail as a soft skill, and academic credentials such as business, legal, or computer science degrees. The disclosed system processes these weighted preferences to return the top candidates (e.g., top five candidates) with the highest computed alignment.

An example recommendation workflow 950 for hiring managers is shown in FIG. 9B, which illustrates how the disclosed system produces optimized candidate recommendations based on hiring manager preferences and candidate features. In the example of FIG. 9B, a hiring manager specifies a set of nine qualifications considered most critical for a specific job role. These qualifications include both technical and non-technical attributes such as job functions (e.g., legal, technology), certifications (e.g., risk, compliance), domain knowledge (e.g., web3 knowledge), demonstrable proof-of-work (e.g., project completion in data analytics), specialized skills (e.g., policy expertise), and soft skills (e.g., attention to detail). Educational requirements, such as degrees in business, law, or computer science, are also included to reflect baseline academic prerequisites.

Each qualification is assigned a ranking by the hiring manager, and the disclosed system uses these rankings to apply weight values. For example, the highest-priority qualification, such as “job function: legal,” may receive the largest weight (e.g., 0.501), followed by the next qualification, “job function: technology,” with a smaller weight (e.g., 0.2505), and so forth. The weight distribution reflects a decreasing geometric sequence, where the most critical criteria dominate the probability calculation while preserving contribution from lower-ranked attributes. This weighting mechanism enables the algorithm to generate probabilistic candidate matches that align most closely with the hiring manager's expressed priorities.

On the candidate side, the disclosed system maintains a structured data representation in which each candidate profile includes binary indicators for every qualification parameter listed in the system's database. A value of “1” denotes that the candidate satisfies the qualification (e.g., has a compliance certification or completed a data analytics project), whereas a value of “0” indicates the absence of that qualification. This binary structure facilitates efficient computational modeling because the Monte Carlo-based algorithm can evaluate match probabilities by sampling candidate vectors against the weighted hiring manager preference vector.

FIG. 9C further illustrates how the disclosed system outputs an ordered list of recommended candidates. In the example 970, the top five candidates with the highest calculated probability of satisfying the selected and weighted qualifications are returned. These candidates are displayed alongside the corresponding job functions or roles they best align with, ensuring that the hiring manager is presented with a prioritized selection of candidates who most strongly match the job requirements as expressed in their preferences.

The recommendation system for hiring managers disclosed herein represents a significant improvement over traditional keyword-matching and static rule-based systems. Conventional systems typically rely on unweighted keyword overlaps, resulting in imprecise candidate rankings. In contrast, the disclosed system employs a probabilistic model that incorporates both explicit hiring manager preferences and binary qualification matrices to produce a dynamic, data-driven ranking of candidate suitability. Furthermore, because the disclosed system supports qualifications beyond static attributes, such as real-world project completions, hackathon participation, and soft skills, the recommendations better reflect practical competencies and cultural fit.

Comparison with Existing Platforms

The disclosed system provides validated, portfolio-driven proof of qualification, supported by intelligent, personalized learning pathways. Unlike existing professional platforms (e.g., LinkedIn), where users manually apply to jobs and list unverifiable experiences, the disclosed system proactively matches hiring managers with talent that has already demonstrated qualification through structured, validated activities. The disclosed system is designed to prioritize proof of qualification over declarations of intent or self-claimed experience.

The disclosed system employs a dynamic, agentic AI to customize each candidate's learning path based on their assessment results, resume data, and even their existing professional profiles (e.g., LinkedIn profiles). Once a job title (e.g., AI prompt engineer) is selected by a user/candidate, the disclosed system can generate a personalized learning and development plan. The agentic AI of the disclosed system functions not merely as a recommender, but as a personal tutor, guiding the user to build a portfolio through relevant projects, courses, and certifications that align with industry needs. In some embodiments, this portfolio serves as the candidate's proof of qualification. Each project and learning milestone is validated and recorded, eliminating ambiguity about the candidate's actual capabilities. In contrast, existing professional platforms lack support for a verified learning path or a validated portfolio tied directly to job readiness. On such platforms, employers often cannot confirm a user's skill beyond potentially unreliable endorsements or vague summaries, even when the listed experience may be fabricated or exaggerated.

In some embodiments, the disclosed system may use blockchain technology for credentialing, which introduces another significant technical advancement. The disclosed system allows each qualification (e.g., associated with a completed course, a passed assessment, or a verified project) to be encoded immutably on a blockchain ledger, making every credential tamper-proof, portable, and verifiable by third parties. Unlike badges or third-party certificates in existing professional platforms that can be revoked or misrepresented, the blockchain-verified credentials used by the disclosed system create a transparent and permanent record of achievement, significantly elevating the trustworthiness of the candidate's profile.

Additionally, the disclosed system may filter out unqualified candidates. The disclosed system displays only candidates who meet specific role requirements to hiring managers, while simultaneously collecting ongoing insights from hiring managers regarding in-demand roles and skills. These inputs are continuously integrated into the disclosed system to update the qualification process and ensure that candidate learning paths remain aligned with real-time recruitment needs. As a result, the disclosed system supports a closed-loop professional pipeline in which assessments inform training/learning, training drives portfolio development, and validated portfolios guide job matching, automating the entire qualification and hiring process. Unlike static, user-curated profiles used in existing professional platforms, the disclosed system dynamically evolves based on both individual learner progress and emerging hiring trends, creating a living, technically verifiable record of demonstrated ability. This makes the disclosed system a responsive and trust-based alternative to existing professional platforms.

### Technical Enhancements

Disclosed above introduces a novel assessment platform and approach for generating accurate and personalized recommendations. Specifically, the disclosed system applies advanced statistical modeling and ML/AI techniques to produce career guidance. Unlike traditional systems that rely on prior experience, personality testing, or technical qualifications, the disclosed system leverages non-parametric, data-driven insights derived from users' hobbies and interests. For example, a user's enjoyment of karaoke may indicate aptitude in auditory processing, which could correlate with success in learning coding languages, particularly those used in blockchain development. The disclosed system utilizes a proprietary algorithm to interpret such associations and align users with relevant career paths in various fields (e.g., web3). The interoperability of the disclosed system with hiring managers and real-time hiring insights makes it an adaptable tool for users (e.g., both students and professionals) seeking entry into emerging fields.

The disclosed system represents a significant advancement in talent discovery and job matching within various domains (including the web3 industry). By leveraging a scalable recommendation engine, the disclosed system can identify transferable skills in unconventional ways. The disclosed system can also analyze large, heterogeneous datasets and iteratively improve through continuous feedback loops, resulting in highly accurate and inclusive recommendations. Below are some core improvements of the disclosed system.

### Dataset Expansion

To enhance model coverage and improve recommendation precision, the disclosed system may expand the number of job titles (e.g., to approximately 450). In some embodiments, the expansion includes incorporating entry-level to senior-level trajectories with cross-industry transition paths. For example, by analyzing historical job trajectories (e.g., derived from professional platforms such as LinkedIn), the disclosed system can provide a clear career path for juniors (e.g., students) to understand how to obtain a senior-level role in the future.

In addition to web3 positions exemplified herein, the disclosed system may also apply to the dataset that includes roles from adjacent and emerging technology fields, such as AI, ML, IoT, zero trust security, cloud security, etc., based on structured surveys and interviews with hiring managers. The disclosed system is able to construct a comprehensive career hierarchy and progression map using data collected from surveys, job boards, and industry reports (e.g., as shown in FIGS. 1A-1G, 6A-6C, 7A-7C, 9A-9C, and 10A-10B), providing a complete and nuanced understanding of career development within various ecosystems.

### Algorithm Refinement

The disclosed system employs a Monte Carlo non-parametric bootstrapping algorithm to model the relationship between user interests and job functions, allowing flexible adaptation to evolving/new data distributions without relying on fixed assumptions used by traditional parametric models (e.g., linear regression).

As the dataset grows in complexity and size, the disclosed algorithm is subjected to extensive testing across diverse user cohorts, including non-web3 professionals, to evaluate and improve algorithm generalizability. When more data (e.g., job titles, user backgrounds, industry reports) are added, the detected user behavior, interests, and career paths vary. The disclosed algorithm is tested on both the target audience (e.g., web3 professionals) and users transitioning from other industries (e.g., non-web3 professionals) to evaluate and improve its performance across different types of users and data scenarios. The disclosed algorithm dynamically and continuously updates as new user profiles and preferences are added (e.g., when new web3 professions input their hobbies and interests). The disclosed algorithm also integrates newly emerging job titles (e.g., web3 job titles) to strengthen dataset coverage and maintain recommendation accuracy over time.

The algorithm refinement also includes modifying the hobby ranking algorithm and adjusting the weighting schema to account for statistical anomalies or inconsistent cluster trends in expanded datasets. For example, as new job titles are added and recommendation outputs are tested, the disclosed system determines whether the algorithm performance remains stable or whether further adjustments are required. Instability may occur, particularly when hobbies and interests associated with a given job function lack consistent trends or exhibit irregular distributions. In such cases, the disclosed system may recalibrate the algorithm weighting to better align with the underlying data. Additionally, the disclosed system may incorporate adaptive decay models and explore context-specific weighting schemes that respond dynamically to variations in data volume and user diversity. For example, when the dataset includes new job titles in emerging fields (e.g., AI, IoT, cloud security, etc.) and specialized roles in diverse domains (e.g., technology, security, finance, accounting, etc.), the disclosed system may revisit the decay rate, determine context-specific weightings, or test alternative decay models to ensure the recommendation generation remains effective. These enhancements help maintain the stability, accuracy, and relevance of generated recommendations.

The disclosed system is further designed to future-proof the recommendation algorithm by enabling the automated ingestion of newly emerging job titles and supporting continuous learning based on alert-driven triggers. When the disclosed system detects potential new roles, such as through job board monitoring or platform activity (e.g., as shown in FIGS. 1A-1G, 9A-9C, and 10A-10B), it can automatically evaluate and incorporate these titles into the dataset. This ensures that the algorithm remains current and responsive to evolving industry demands, without requiring manual reconfiguration.

### Feedback-Based Model Improvement

The disclosed system incorporates a dynamic feedback-driven optimization mechanism that tracks, analyzes, and utilizes user responses to continuously improve the accuracy and relevance of job recommendations. This mechanism allows for real-time adjustments, such as re-ranking hobbies, refining algorithmic weightings, and incorporating hiring managers' insights into the recommendation process. Unlike conventional job recommendation platforms that rely on static profile data and historical patterns, the disclosed system integrates multi-stage user feedback from both candidates and hiring managers, providing a self-learning capability that enhances personalization and predictive accuracy over time.

The user feedback may include explicit user responses such as interactive indicators (e.g., thumbs up, thumbs down) on the recommended job functions and titles and implicit user responses such as user activities associated with the job recommendations. Feedback from hiring managers, such as prioritization of qualifications, preferences for soft skills, and evaluations of past recommendations, is also incorporated. These feedback signals are captured at various stages of the recommendation process to dynamically refine the algorithmic weighting of features, including hobbies, skills, and career interests.

In some embodiments, the disclosed system may compute and monitor error rates associated with specific job functions both before and after a user completes a qualification or assessment. To assess user perception shifts and validate recommendation accuracy, the disclosed system presents targeted pre- and post-assessment questions. For example, before an assessment, the user may be asked: “Before participating in this assessment, had you ever considered a career in Web3?” Following the assessment, a related question such as “Now that you have completed the assessment, will you apply to at least one job in Web3?” may be presented. Similarly, the disclosed system can evaluate changes in perceived knowledge by asking questions such as: “Before participating in this assessment, how would you rate your knowledge of Web3 careers? (scale 1-5)” and “After participating in this assessment, how would you rate your knowledge of Web3 careers? (scale 1-5).” Different types and numbers of questions can be administered to measure changes in user interest and understanding at multiple stages of assessment and recommendation generation.

By aggregating these responses across users, the disclosed system may calculate an error rate that reflects the degree of mismatch between initial recommendations and user satisfaction or qualification outcomes. In some embodiments, an error can be defined when a user provides a specific input sequence (such as hobbies or skills) and receives a recommended job function that they later indicate as undesirable or irrelevant. An error rate for that recommendation pattern can be computed as:

$$Error rate = \frac{\# of users who disliked the job recommendation}{\# of users with the same input pattern} \times 100$$

Once error rates are determined, the disclosed system applies a penalization strategy to improve future recommendations. Job functions associated with high error rates are penalized within the matching algorithm, reducing their likelihood of appearing for similar input patterns. This re-weighting approach enables the disclosed system to adaptively deprioritize recommendations that have historically produced low satisfaction, thereby improving precision and relevance over time.

In some embodiments, the disclosed system may employ predefined thresholds to determine when corrective action is required. For example, error rates below 10% are considered acceptable, error rates between 10% and 25% indicate a moderate concern and may trigger a review, and error rates exceeding 25% prompt immediate corrective measures, including strong penalization or re-weighting within the recommendation algorithm.

In some embodiments, when the computed error rate for a given job title exceeds a threshold, the system may automatically adjust or reclassify that job title, update qualification criteria associated with the role, or modify algorithmic weightings applied to that role in future recommendations. This continuous feedback loop ensures that the recommendation engine remains dynamic, self-correcting, and aligned with both evolving industry requirements and real-world user activities, thereby delivering an optimized experience for candidates and hiring managers.

In some embodiments, the disclosed system may calculate hiring manager insights by aggregating data, such as the qualifications most frequently requested, candidate features correlated with successful placements, and trends derived from prior hiring decisions, etc. This data may further be combined with market intelligence (e.g., emerging job roles, in-demand certifications, or trending skill sets) to ensure that the disclosed system adapts to evolving industry conditions.

The disclosed system may also leverage an agentic AI module/advisor to proactively engage hiring managers with curated talent insights, relevant job descriptions, and data-driven recommendations. This AI module is envisioned to serve as a trusted advisor, capable of conducting interactive chats with hiring managers to highlight qualified candidates, suggest optimal job requirements, and provide real-time market analysis. By integrating this proactive, conversational interface, hiring managers can refine their talent search strategies more effectively, while the disclosed system continuously learns from these interactions to improve the quality and precision of recommendations.

This agentic AI advisor represents an important differentiator from conventional job-matching platforms (e.g., LinkedIn), which are largely passive, requiring hiring managers to manually define job postings and search through candidate profiles based on static keyword-based filters or historical data. In contrast, the disclosed agentic AI advisor proactively engages with hiring managers through an interactive conversational interface, providing real-time insights into candidate pools, recommending optimal qualification criteria, and highlighting emerging market trends relevant to the role. This AI advisor can dynamically analyze data from multiple sources, including user assessments, candidate project completions, hiring manager preferences, and industry-wide demand signals, to suggest adjustments to job descriptions and qualification weightings. By serving as a trusted partner that not only surfaces top talent but also provides data-driven recommendations on how to refine the hiring strategy, the disclosed system delivers a level of personalization and adaptability that is not achievable with static, profile-driven systems (e.g., LinkedIn).

In some embodiments, the disclosed system may integrate supervised learning and reinforcement learning techniques to improve recommendation accuracy based on real-time user feedback. For example, a supervised learning model (e.g., gradient-boosted decision trees or a neural network) may be trained on a labeled dataset that includes features such as hobby selections, recommendation context (e.g., time of day, prior interaction history), and the associated user feedback labels (e.g., positive or negative). The disclosed system learns to predict the likelihood of user approval for a given job recommendation and adjusts the future outputs of the model accordingly. In another example, the disclosed system may employ a reinforcement learning (RL) framework in recommendation generation, where reward signals are dynamically adjusted based on user feedback. Positive feedback (e.g., thumbs up) increases a reward value associated with similar future recommendations, while negative feedback decreases the reward value. Over time, the disclosed system iteratively learns and converges toward a recommendation policy that maximizes cumulative user satisfaction. By integrating these learning-based feedback loops, the disclosed system can iteratively refine its prediction models, improving recommendation relevance and system responsiveness in the long run.

### System Infrastructure Enhancements

To support scalability and a growing user base, the disclosed system may upgrade the user interface display to allow a fast, responsive frontend that can adapt to increased traffic. To enhance security and streamline access, the disclosed system may implement passwordless authentication (e.g., via Azure® active directory business-to-customer (AD B2C)), providing a seamless and secure login experience for users with multi-factor authentication implemented for sensitive operations.

On the backend, the architecture of the disclosed system may be significantly enhanced by migrating microservices to cloud-based container orchestration services (e.g., Azure® Kubernetes service (AKS)), allowing for dynamic scaling based on real-time load demands. Data access may be optimized through advanced partitioning and indexing strategies to ensure high-performance querying and storage scalability. Additionally, serverless execution of dynamic tasks may be implemented to enhance system flexibility and efficiency. For example, the disclosed system may utilize real-time data pipelines to process user interaction data in order to obtain timely insights and improvements to the backend infrastructure, thereby ensuring the disclosed system remains responsive and efficient at full scale.

Additionally, for security and compliance, the disclosed system may integrate a secure, payment card industry data security standard (PCI-DSS) compliant payment processing service. A cloud-based threat detection system may also be configured for continuous monitoring, while a security management and auditing service may be used to support regular assessments and platform hardening, ensuring a secure and resilient system as it scales.

In some embodiments, a model context protocol (MCP) may be employed to allow the agentic AI to retrieve real-time data from external sources without manual input. This protocol supports seamless integration with live data pipelines, allowing dynamic context to be fed back into the AI model. As a result, the disclosed system can deliver more accurate, relevant, and timely recommendations or guidance.

### Validation and Continuous Model Tuning

To ensure the accuracy and effectiveness of the generated recommendation, the disclosed system may undergo A/B testing and structured multi-group trials including students, professionals from non-web3 industries with transferable skills, innovative professionals in emerging technology fields such as AI, LoT, cloud security, web3, etc. The data collected from these trials may then be used to fine-tune the relevance of the recommendation algorithm, optimize decay rates used in ranking hobby-to-job associations, and reweight key features that influence career-matching outcomes. In some embodiments, recommendation performance may be measured using quantitative metrics such as relevance scores, increases in career knowledge, and user satisfaction indices. This iterative process ensures that the model remains aligned with user needs and continues to deliver accurate, high-impact recommendations across diverse user groups.

### Flowcharts

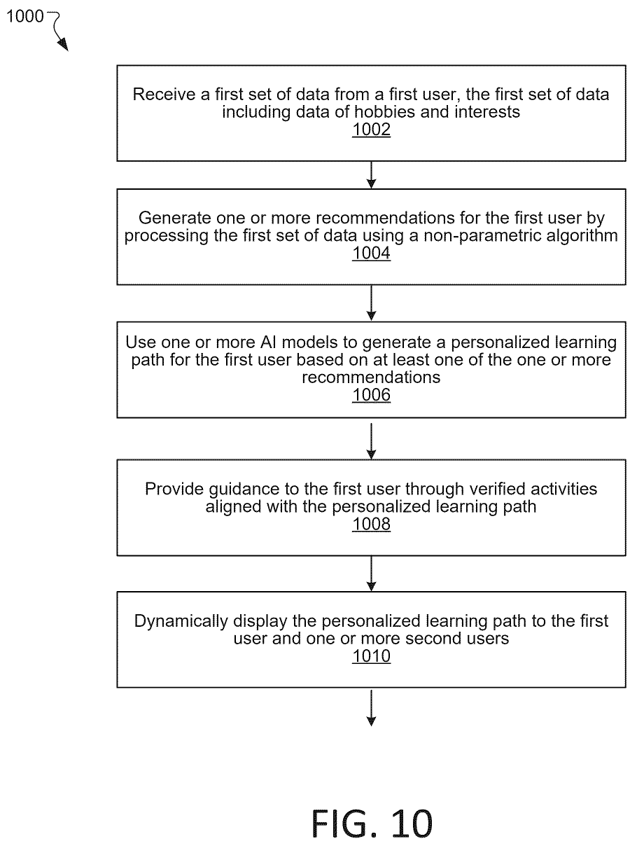

FIG. 10 illustrates a flowchart 1000 of generating recommendations and personalized learning paths, according to some embodiments. At step 1002, a first set of data is received from a first user. In the context of employment recommendation generation, the first user can be a student or a professional seeking a job match. The first set of data includes data on hobbies and interests. Instead of depending on prior experience, personality testing, or technical qualifications, the disclosed system applies advanced statistical modeling and ML/AI techniques to produce career guidance.

At step 1004, one or more recommendations are generated for the first user by processing the first set of data using a non-parametric algorithm. In some embodiments, the non-parametric algorithm includes a bootstrap and Monte Carlo algorithm. The recommendations include job titles that match the first user's hobbies, interests, as well as other relevant factors (e.g., academic background).

At step 1006, the disclosed system uses one or more AI models to generate a personalized learning path for the first user. In some embodiments, once the first user selects a recommendation (e.g., job title) from the one or more provided recommendations, the disclosed system may trigger an AI agent to generate a personalized learning path, which includes one or more of personalized educational courses, projects, or tutorials. In some embodiments, the disclosed system may obtain a user profile (e.g., skill profile) of the first user, identify a gap between the user profile of the first user and a qualification structure associated with the at least one of the one or more recommendations, and generate the personalized learning path based on the identified gap. The disclosed system may track and adapt the learning path as the first user progresses.

At step 1008, the disclosed system provides guidance to the first user through verified activities aligned with the personalized learning path. For example, as the first user progresses through the learning path, the disclosed system may incorporate performance feedback, such as completion status, time spent on tasks, and quiz results, to dynamically adjust and reprioritize the next set of recommended learning activities.

At step 1010, the disclosed system dynamically displays the personalized learning path to the first user and one or more second users. The second users can be an administrator, a hiring manager, etc. Distinct dashboards may be generated for displaying relevant data to the second users. For example, the hiring manager dashboard may be provided to display only qualified first users who each have completed a corresponding personalized learning path and achieved a predefined qualification status (e.g., “VIP” status).

### Computer Implementation

In some examples, some or all of the processing described above can be carried out on a personal computing device, on one or more centralized computing devices, or via cloud-based processing by one or more servers. Some types of processing can occur on one device and other types of processing can occur on another device. Some or all of the data described above can be stored on a personal computing device, in data storage hosted on one or more centralized computing devices, and/or via cloud-based storage. Some data can be stored in one location and other data can be stored in another location. In some examples, quantum computing can be used, and/or functional programming languages can be used. Electrical memory, such as flash-based memory, can be used.

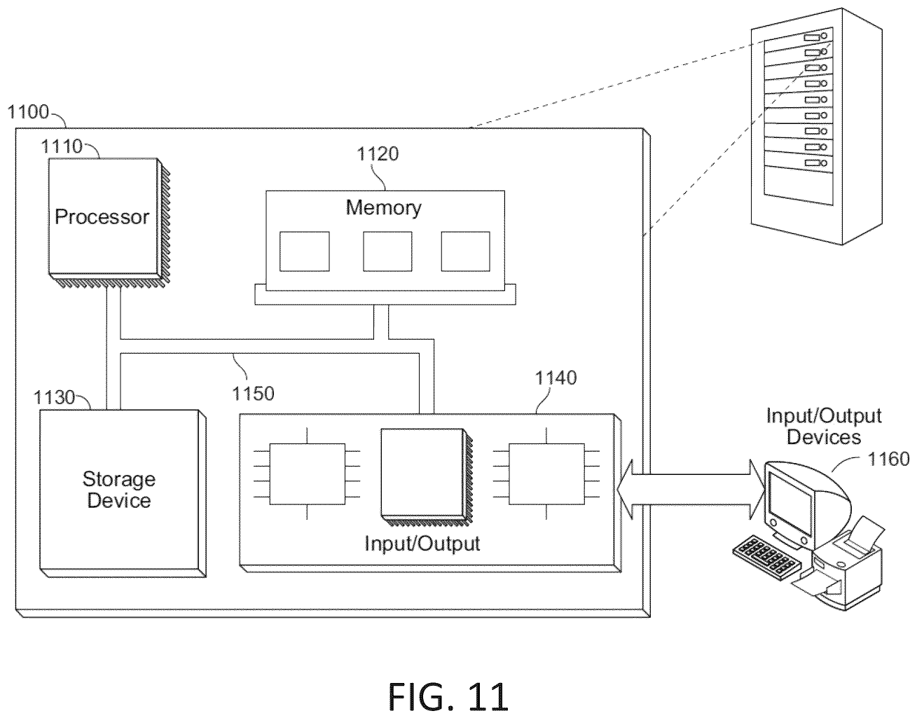

FIG. 11 is a block diagram of an example computer system 1100 that may be used in implementing the technology described herein. General-purpose computers, network appliances, mobile devices, or other electronic systems may also include at least portions of the system 1100. The system 1100 includes a processor 1110, a memory 1120, a storage device 1130, and an input/output device 1140. Each of the components 1110, 1120, 1130, and 1140 may be interconnected, for example, using a system bus 1150. The processor 1110 is capable of processing instructions for execution within the system 1100. In some implementations, the processor 1110 is a single-threaded processor. In some implementations, the processor 1110 is a multi-threaded processor. The processor 1110 is capable of processing instructions stored in the memory 1120 or on the storage device 1130.

The memory 1120 stores information within the system 1100. In some implementations, the memory 1120 is a non-transitory computer-readable medium. In some implementations, the memory 1120 is a volatile memory unit. In some implementations, the memory 1120 is a non-volatile memory unit.

The storage device 1130 is capable of providing mass storage for the system 1100. In some implementations, the storage device 1130 is a non-transitory computer-readable medium. In various different implementations, the storage device 1130 may include, for example, a hard disk device, an optical disk device, a solid-state drive, a flash drive, or some other large capacity storage device. For example, the storage device may store long-term data (e.g., database data, file system data, etc.). The input/output device 1140 provides input/output operations for the system 1100. In some implementations, the input/output device 1140 may include one or more network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 1160. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 1130 may be implemented in a distributed way over a network, such as a server farm or a set of widely distributed servers, or may be implemented in a single computing device.

Although an example processing system has been described in FIG. 11, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special-purpose logic circuitry, e.g., an FPGA (field programmable gate array) or an ASIC (application-specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program can include, by way of example, general or special purpose microprocessors or both, or any other kind of central processing unit. Generally, a central processing unit will receive instructions and data from a read-only memory, a random access memory, or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special-purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A computer-based method for generating recommendations and personalized learning paths, the method comprising:
receiving, at a computing system comprising a processor and a memory, a first set of data from a first user, the first set of data including data of hobbies and interests;
generating, by the processor, one or more recommendations for the first user by processing the first set of data using a non-parametric algorithm;
using, by the processor, one or more artificial intelligence (AI) models to generate a personalized learning path for the first user based on at least one of the one or more recommendations;
providing, by the processor, guidance to the first user through verified activities aligned with the personalized learning path; and
dynamically displaying, by the processor, the personalized learning path to the first user and one or more second users.

2. The method of claim 1, wherein the non-parametric algorithm includes a bootstrap and Monte Carlo algorithm.

3. The method of claim 2, wherein the recommendations include one or more job titles, the method further comprising:
providing a plurality of job functions that match the first set of data associated with the first user;
identifying, from the plurality of job functions, one or more job functions based on analyzing a second set of data associated with the first user, the second set of data including academic data;
determining one or more job titles that align with the first and second sets of data; and
presenting the one or more job titles as recommendations to the first user.

4. The method of claim 1, wherein generating the one or more recommendations comprises applying a hobby ranking algorithm and weighting schema.

5. The method of claim 4, further comprising:
tracking user input from the first user and the one or more second users;
modifying the hobby ranking algorithm and weighting schema based on the user input; and
updating the one or more recommendations.

6. The method of claim 1, further comprising:
obtaining a user profile of the first user;
identifying a gap between the user profile of the first user and a qualification structure associated with the at least one of the one or more recommendations; and
generating the personalized learning path based on the identified gap.

7. The method of claim 6, wherein the user profile includes a skill profile, and the learning path includes one or more of personalized educational courses, projects, or tutorials.

8. The method of claim 7, further comprising:
determining user performance metrics representing the first user's engagement, completion, or assessment outcomes of the personalized learning path; and
updating the personalized learning path using the user performance metrics and the one or more AI models.

9. The method of claim 1, wherein dynamically displaying the personalized learning path comprises generating a graphical user interface for providing a manager dashboard to at least one of the one or more second users.

10. The method of claim 9, wherein the manager dashboard is provided to track and display validated learning progress and portfolio submissions of the first user, and receive feedback from the at least one of the one or mores second users.

11. The method of claim 1, wherein dynamically displaying the personalized learning path comprises generating a graphical user interface for providing a hiring manager dashboard to at least one of the one or more second users.

12. The method of claim 11, wherein the hiring manager dashboard is provided to display only qualified first users who each have completed a corresponding personalized learning path and achieved a predefined qualification status.

13. The method of claim 11, wherein the hiring manager dashboard is provided to receive real-time insights from the at least one of the one or more second users.

14. A computing system for generating recommendations and personalized learning paths, the computing system comprising:
a processor; and
a memory in communication with the processor and comprising instructions which, when executed by the processor, program the processor to:
receive a first set of data from a first user, the first set of data including data of hobbies and interests;
generate one or more recommendations for the first user by processing the first set of data using a non-parametric algorithm;
use one or more artificial intelligence (AI) models to generate a personalized learning path for the first user based on at least one of the one or more recommendations;
provide guidance to the first user through verified activities aligned with the personalized learning path; and
dynamically display the personalized learning path to the first user and one or more second users.

15. The system of claim 14, wherein the non-parametric algorithm includes a bootstrap and Monte Carlo algorithm.

16. The system of claim 15, wherein the recommendations include one or more job titles, and the instructions further program the processor to:
provide a plurality of job functions that match the first set of data associated with the first user;
identify, from the plurality of job functions, one or more job functions based on analyzing a second set of data associated with the first user, the second set of data including academic data;
determine one or more job titles that align with the first and second sets of data; and
present the one or more job titles as recommendations to the first user.

17. The system of claim 16, wherein the instructions further program the processor to:
determine a user profile of the first user;
identify a gap between the user profile of the first user and a qualification structure associated with the at least one of the one or more recommendations; and
generate the personalized learning path based on the identified gap.

18. The system of claim 14, wherein dynamically displaying the personalized learning path comprises generating a graphical user interface for providing a manager dashboard or a hiring manager dashboard to at least one of the one or more second users.

19. The system of claim 18, wherein the instructions further program the processor to receive feedback from the at least one of the one or mores second users through the graphcical user interface.

20. A computer program product for generating recommendations and personalized learning paths, the computer program product comprising a non-transitory computer-readable medium having computer readable program code stored thereon, the computer readable program code configured to:
receive a first set of data from a first user, the first set of data including data of hobbies and interests;
generate one or more recommendations for the first user by processing the first set of data using a non-parametric algorithm;
use one or more artificial intelligence (AI) models to generate a personalized learning path for the first user based on at least one of the one or more recommendations;
provide guidance to the first user through verified activities aligned with the personalized learning path; and
dynamically display the personalized learning path to the first user and one or more second user.
